(19) United States
(12) Patent Application Publication
(10) Pub. No.: US 2018/0182030 A1
(43) Pub. Date: Jun. 28, 2018

(54) DETERMINATION DEVICE, DETERMINATION METHOD, AND NON-TRANSITORY COMPUTER-READABLE RECORDING MEDIUM

(71) Applicant: YAHOO JAPAN CORPORATION, Tokyo (JP)

(72) Inventors: Kyosuke ARAI, Tokyo (JP); Shinichiro SEGA, Tokyo (JP); Yohei YAMAUE, Tokyo (JP)

(73) Assignee: YAHOO JAPAN CORPORATION, Tokyo (JP)

(21) Appl. No.: 15/822,858

(22) Filed: Nov. 27, 2017

(30) Foreign Application Priority Data
Dec. 27, 2016 (JP) 2016-254293

(51) Int. Cl. G06Q 40/02; G06Q 30/02; G06F 17/30

(52) U.S. Cl. CPC G06Q 40/025; G06F 17/30958; G06Q 30/0242

(57) ABSTRACT

A determination device disclosed herein includes an acquiring unit, a specifying unit, and a determination unit. The acquiring unit acquires account information that is information related to a transaction of an account opened by a first company and evaluation information that is information related to evaluations of companies. The specifying unit specifies, based on the account information acquired by the acquiring unit, a second company that has a deposit/withdrawal transaction with the first company. The determination unit determines, based on the evaluation information related to the second company specified by the specifying unit and based on the information related to the deposit/withdrawal transaction between the first company and the second company, the creditworthiness of the first company.

### CROSS-REFERENCE TO RELATED APPLICATION(S)

The present application claims priority to and incorporates by reference the entire contents of Japanese Patent Application No. 2016-254293 filed in Japan on Dec. 27, 2016.

### BACKGROUND OF THE INVENTION

### 1. Field of the Invention

The present invention relates to a determination device, a determination method, and a non-transitory computer-readable recording medium having stored therein a determination program.

### 2. Description of the Related Art

In general, when a financial institution, such as a bank, decides a borrower, the financial institution performs determination of the creditworthiness of a company that becomes the borrower. Namely, by investigating, for example, a financial situation of the company and measuring the creditworthiness of the company, the financial institution decides information about a loan indicating whether the loan is to be given to the subject company or how much of the loan is to be set. Furthermore, the information, such as the creditworthiness of the company, is sometimes provided from external institutions specializing in collecting or analyzing enterprise information, instead of being determined by the financial institution itself.

Here, as an example of a technology of determining the creditworthiness of a company, there is a known technology of calculating fund traces by using transfer data. With this technology, the flow of the company fund can be graphically indicated without depending on information on the main customers obtained from financial statements or the external institutions (for example, refer to JP 2015-88037 A).

However, in the conventional technology described above, it is difficult to appropriately extract companies that become borrowers. Specifically, the conventional technology merely creates a graph that reflects transactions between enterprises by calculating the fund traces using the transfer data. Consequently, in the conventional technology, it is not always able to extract a company that is assumed to become a borrower beneficial for the financial institution.

### SUMMARY OF THE INVENTION

It is an object of the present invention to at least partially solve the problems in the conventional technology.

A determination device according to the present application includes an acquiring unit that acquires account information that is information related to a transaction of an account opened by a first company and evaluation information that is information related to evaluations of companies, a specifying unit that specifies, based on the account information acquired by the acquiring unit, a second company that has a deposit/withdrawal transaction with the first company, and a determination unit that determines, based on the evaluation information related to the second company specified by the specifying unit and based on the information related to the deposit/withdrawal transaction between the first company and the second company, creditworthiness of the first company.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of a determination process according to an embodiment;

FIG. 2 is a diagram illustrating a configuration example of a determination system according to the embodiment;

FIG. 3 is a diagram illustrating a configuration example of a determination device according to the embodiment;

FIG. 4 is a diagram illustrating an example of an account information storage unit according to the embodiment;

FIG. 5 is a diagram illustrating an example of a stock price table according to the embodiment;

FIG. 6 is a diagram illustrating an example of an exchange table according to the embodiment;

FIG. 7 is a diagram illustrating an example of a search data table according to the embodiment;

FIG. 8 is a diagram illustrating an example of a news data table according to the embodiment;

FIG. 9 is a diagram illustrating an example of an advertisement table according to the embodiment;

FIG. 10 is a diagram illustrating an example of a company information storage unit according to the embodiment;

FIG. 11 is a flowchart (1) illustrating the flow of a process according to the embodiment;

FIG. 12 is a flowchart (2) illustrating the flow of a process according to the embodiment;

FIG. 13 is a diagram illustrating an example of a creating process according to a modification; and

FIG. 14 is a hardware configuration diagram illustrating an example of a computer that implements functions of the determination device.

### DETAILED DESCRIPTION OF THE PREFERRED EMBODIMENTS

A mode (hereinafter, referred to as an “embodiment”) for carrying out determination device, a determination method, and a non-transitory computer-readable storage medium having stored therein a determination program according to the present application will be described in detail below with reference to the accompanying drawings. The determination device, the determination method, and the non-transitory computer-readable storage medium having stored therein the determination program are not limited by the embodiment. Furthermore, in the embodiments below, the same components are denoted by the same reference numerals and an overlapping description will be omitted.

### 1. Example of a Determination Process

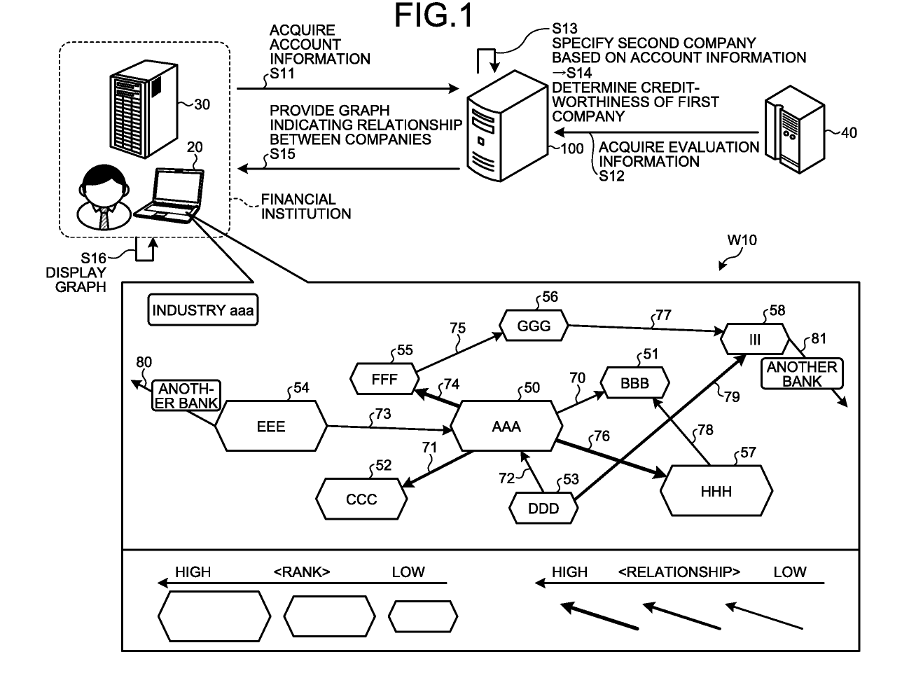

First, an example of a determination process according to the embodiment will be described with reference to FIG. 1. FIG. 1 is a diagram illustrating an example of the determination process according to an embodiment. In FIG. 1, an example of a process in which a determination device 100 according to the embodiment determines the creditworthiness of a predetermined company as a borrower from a financial institution will be described. Furthermore, in FIG. 1, a description will be given of an example of a process in which the determination device 100 provides a determination result to a financial institution terminal 20 that is a terminal device used in the financial institution. The company mentioned here is not limited to an enterprise but is the concept widely including all kinds of business, such as a private business owner, a small-scale corporation, or the like.

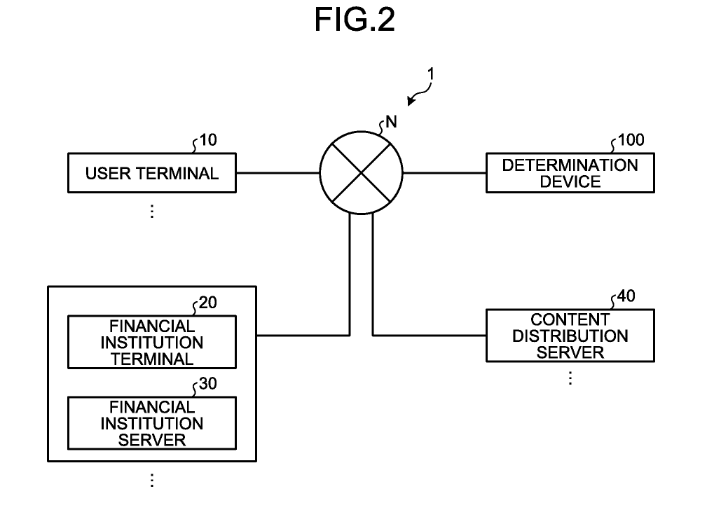

The determination device 100 illustrated in FIG. 1 is a server device that determines the creditworthiness of a company as a borrower. Furthermore, the financial institution terminal 20 illustrated in FIG. 1 is an information processing terminal used by a financial institution. Furthermore, a financial institution server 30 illustrated in FIG. 1 is a server device held in the financial institution. Furthermore, a content distribution server 40 illustrated in FIG. 1 is a server device that distributes, for example, content, such as web sites, to a general user (not illustrated in FIG. 1). The determination device 100, the financial institution terminal 20, the financial institution server 30, and the content distribution server 40 are connected so as to be mutually communicated with each other via a network N (for example, the Internet. See FIG. 2) that is not illustrated in FIG. 1.

The determination device 100 determines the creditworthiness of the company by using, for example, a predetermined index value. Specifically, the determination device 100 calculates the index value of the subject company based on the capability or the operation status of the company and determines the creditworthiness of the subject company based on the calculated numerical value. Furthermore, as described below, the determination device 100 determines the creditworthiness of the target company based on information on another company that has a relationship with the company in which the creditworthiness is to be determined.

Furthermore, the determination device 100 provides the determined creditworthiness to a financial institution that gives a loan to the company. In general, a financial institution conducts its own investigation of a company and determines the creditworthiness of the company as a borrower. For example, the financial institution determines the creditworthiness of the company as a borrower by cooperating with an external institution, such as an investigation firm, that specializes in investigating the financial situation or the like of the company.

However, with a technique described above, it is sometimes difficult for a financial institution to expand the number of borrowers. For example, investigation firms or financial institutions can acquire the financial situations of relatively large-scale listed joint-stock corporations but does not always acquire the financial situations about venture enterprises or the like that have just been established. Consequently, the financial institutions are sometimes not able to appropriately conduct business operations with respect to these small-scale companies or appropriately calculate a loan amount. Furthermore, there is a possibility that the financial institutions are not able to recognize these companies as borrowers without being aware of these small-scale companies.

Thus, the determination device 100 according to the embodiment determines the creditworthiness of the companies by using the process described below and provides a graph that displays a list of determination results to a financial institution. Consequently, the financial institution can extract appropriate companies as borrowers and expands the number of borrowers.

Specifically, regarding a company (hereinafter, sometimes referred to as a “first company”) targeted for determination of the creditworthiness as a borrower, the determination device 100 performs a determination process by using not only information on the subject company itself but also information on a company (hereinafter, sometimes referred to as a “second company”) that has a predetermined relationship with the subject company. More specifically, the determination device 100 acquires information related to an account (hereinafter, sometimes referred to as “account information”) opened in the financial institution by the first company.

In general, it is assumed that, even if the company is small in scale, the company almost certainly opens an account that is used its business. The determination device 100 acquires the account information that is information on the account opened by the first company from the financial institution and specifies the second company that has a transaction with the first company from the account information. Then, the determination device 100 determines the creditworthiness of the first company by using the information related to the specified second company. Namely, the determination device 100 determines the creditworthiness of the first company by using the information related to the second company that has a business relationship with the first company. Consequently, even in a case where it is difficult to determine the creditworthiness due to the first company being a small-scale company, such as an unlisted company, a venture enterprise, or the like, by using financial information on the first company itself, the determination device 100 can accurately determine the creditworthiness of the first company. An example of the determination process performed by the determination device 100 will be described with reference to FIG. 1.

First, the determination device 100 acquires the account information on the first company from the financial institution server 30 in cooperation with the financial institution (Step S11). Furthermore, the determination device 100 acquires, from the content distribution server 40, information related to evaluation (hereinafter, sometimes referred to as “evaluation information”) of companies (including both the first company and the second company when denoted as companies unless otherwise noted in a description below (Step S12).

The determination device 100 acquires various kinds of information as the evaluation information. For example, if the content distribution server 40 is a server that provides web sites related to stock information, the determination device 100 acquires, as the evaluation information, current stock price information on companies or the transition of the stock price information. Furthermore, if the content distribution server 40 is a server that provides web sites related to exchange, the determination device 100 acquires exchange information, as the evaluation information, information on current exchange or information indicating the movement of exchange in the industry belonging to companies.

Furthermore, if the content distribution server 40 is a server that provides web sites related to search services, the determination device 100 acquires, as the evaluation information, the number of times companies are searched for by users or the ranking of the companies. Furthermore, if the content distribution server 40 is a server that provides web sites related to news services, the determination device 100 acquires, as the evaluation information, information indicating the number of times the companies have appeared in articles, information indicating whether the articles are positive articles or negative articles with respect to the companies. The pieces of the evaluation information described above are examples and the other pieces of evaluation information in detail will be described later.

Then, the determination device 100 performs a process of determining the creditworthiness of the first company based on the information acquired from the financial institution server 30 and the content distribution server 40. Specifically, the determination device 100 specifies, based on the account information acquired from the financial institution server 30, the second company that has a relationship with the first company (Step S13).

For example, the determination device 100 specifies, as the second company based on the account information on the first company, the company that has a business relationship with the first company. Specifically, the determination device 100 specifies, as the second company, the company that is listed, as a history of the deposit/withdrawal destination, in the account of the first company. In this case, in addition to specifying the second company, the determination device 100 may also specify information, such as an transaction amount between the first and the second companies, the transaction date and time, the transaction frequency, the transition of transaction amount, or the like.

Then, based on the deposit/withdrawal relationship between the specified second company and the first company and based on the evaluation information related to the second company, the determination device 100 determines the creditworthiness of the first company as a borrower (Step S14). The deposit/withdrawal relationship mentioned here includes information related to a deposit/withdrawal transaction between the first company and the second company indicating, for example, the relationship between the first company and the second company in which a transaction including deposits/withdrawals has occurred, a transaction amount, the number of transactions, or the like. However, as will be described in detail later, if, for example, the transaction amount with the second company is increasingly changed and the second company receives an evaluation higher than other companies, the determination device 100 determines that the creditworthiness of the first company having a relationship with the second company is high. Namely, the determination device 100 determines the creditworthiness of the first company based on the evaluation of the second company that has the relationship with the first company.

For example, if the first company is a venture enterprise or the like and is an unlisted company, in general, the financial information or the like is not opened to the public. Consequently, it is difficult for a financial institution or the like to measure the creditworthiness of the first company based on the information only on the first company. In contrast, the determination device 100 can determine the creditworthiness of the first company by specifying the second company that has a business relationship with the first company and by using the information related to the second company. For example, regarding the first company that has a business relationship with the second company having favorable business or having socially high creditworthiness or regarding the first company having an increasing trend in transaction amount, the determination device 100 reflects these elements and determines that the first company has relatively high creditworthiness.

Furthermore, the determination device 100 may also provide a predetermined user interface that displays a list of relationships between the determined creditworthiness and the account held by the first company. For example, the determination device 100 creates a graph W10 illustrated in FIG. 1. Then, the determination device 100 provides the created graph W10 to the financial institution terminal 20 (Step S15). The financial institution terminal 20 displays the graph W10 provided from the determination device 100 (Step S16). For example, the staff of the financial institution who uses the financial institution terminal 20 extracts, by using the graph W10, the first company that becomes a new borrower.

As illustrated in FIG. 1, the graph W10 that indicates the relationship between the companies and the creditworthiness thereof is visually displayed by using the companies and the lines connecting the companies. For example, in the graph W10, a predetermined first company is used as the reference point and the second company having a connection with the first company that is used as the reference point is visually displayed. Furthermore, the second company with respect to the first company that is used as the reference point newly becomes the first company and, furthermore, the relationship with the second company having the relationship with the subject first company is displayed in the graph W10.

Specifically, in the graph W10, each of the companies is displayed as a graph represented by nodes and edges (branches, sides, lines) that connect each node having the linkage. Furthermore, in a description below, each of the companies is sometimes represented by a node and each of the edges connecting the nodes is sometimes represented by a line. Furthermore, the determination device 100 may also create the graph W10 for each industry (an “industry aaa” in the example illustrated in FIG. 1) to which, for example, the first company belongs.

For example, in FIG. 1, it is assumed that a node 50 is a node that represents the first company associated with a company AAA (represented by “AAA” illustrated in FIG. 1) and is used as the reference point node at this point. Furthermore, each of the nodes is connected by a line, which indicates that each of the nodes has a connection with the other nodes. For example, in FIG. 1, the node 50 has a line 70, a line 71, a line 72, a line 73, a line 74, and a line 76. In this case, the company AAA associated with the node 50 has a connection with each of the companies associated with the nodes that are connected by the lines.

In the example illustrated in FIG. 1, in the graph W10, the node 50 is connected to a node 51, a node 52, a node 53, a node 54, a node 55, and a node 57. This indicates that the company AAA associated with the node 50 has a business relationship with the company associated with each of the nodes in terms of their account.

In the graph W10, the relationships between the companies other than the company AAA are displayed. For example, the graph W10 indicates that the node 55 has a line 75 and has also a business relationship with a node 56. Furthermore, the graph W10 indicates that the node 57 has a line 78 and has also a business relationship with the node 51. Furthermore, the graph W10 indicates that the node 53 has a line 79 and has also a business relationship with a node 58. Furthermore, the graph W10 indicates that the node 56 has a line 77 and has also a business relationship with the node 58. Furthermore, the graph W10 indicates that the node 54 has a line 80 to which the character of “another bank” is attached. Furthermore, the node 58 has a line 81 and “another bank” is also attached to the line 81. This indicates that each of the companies associated with the node 54 or the node 58 has a business relationship with the companies that have their accounts in the other bank. If the determination device 100 is also able to acquire the account information from a financial institution that is other than the financial institution illustrated in FIG. 1, the determination device 100 may also further specify the node connected to, for example, the node 54 and display the specified node in the graph W10. In this way, the determination device 100 creates the graph W10 in a mode of display in which the relationships between the companies can easily be understood at a glance.

Furthermore, the determination device 100 may also perform a predetermined display adjustment process without displaying all of the companies each having a connection with the company AAA in the graph W10. Specifically, the determination device 100 may also display, in the relationship with the company AAA, only the second company in which the transaction amount exceeds a certain threshold as a node. This process is performed in order to improve the visibility of the graph W10 by excluding, in the determination process, a display of the companies having a lower weight from the companies that are displayed on the graph W10.

Furthermore, as illustrated in FIG. 1, the determination device 100 may also create the graph W10 representing the creditworthiness of the companies based on the size of the nodes. For example, the determination device 100 allows the size of the nodes associated with the companies in each of which the determination creditworthiness exceeds a predetermined threshold to be the largest. In the example illustrated in FIG. 1, the level of creditworthiness is represented by a “rank”. Namely, the companies are determined in a higher rank as the companies determined by the determination device 100 that the creditworthiness thereof is higher and then the companies are represented large in size in the graph W10.

Furthermore, in the graph W10, the determination device 100 may also indicates the deposit/withdrawal relationship between the companies by using the orientation of arrows. For example, if the company AAA has a relationship in which the company AAA makes a deposit to the second company (the relation in which the company AAA makes a payment), the determination device 100 adds the arrow of the line connecting the company AAA to the second company so as to be oriented to the second company side. Furthermore, if the company AAA has the relation in which the company AAA receives a deposit from the second company (the relation in which the second company side makes a payment), the determination device 100 adds the arrow of the line connecting the company AAA to the second company so as to be oriented to the company AAA side.

Furthermore, the determination device 100 may also change the width of the line displayed in the graph W10 in accordance with the transaction amount. For example, the determination device 100 may also create the graph W10 representing the line thicker as the transaction amount is increased between companies. Furthermore, because a difference is generated in the absolute values of the transaction amount due to the scale of the companies, the determination device 100 may also change the thickness of the line in accordance with, instead of the transaction amount itself, for example, fluctuations in the ratio of transaction amount of the first company or the transition of the transaction amount (for example, the rate of increase when compared with the transaction amount occurred a week before or the like).

Furthermore, the determination device 100 may also receive a request for the visual representation described above from a person who uses the graph W10. Namely, the determination device 100 may also receive a request for designation of the size of the node or the thickness of the line and may also provide a user interface that creates the graph W10 in accordance with the request.

As described above, the determination device 100 according to the embodiment acquires the account information that is the information related to a transaction of the account opened by the first company and the evaluation information that is the information related to evaluations of companies. Then, the determination device 100 specifies, based on the acquired account information, the second company that has a business relationship with the first company. Furthermore, based on the deposit/withdrawal relationship between the specified second company and the first company and based on the evaluation information related to the second company, the determination device 100 determines the creditworthiness of the first company as a borrower.

In this way, the determination device 100 according to the embodiment determines the creditworthiness of the first company as a borrower by using the deposit/withdrawal relationship between the first company and the second company or by using the evaluation information on the second company that has a business relationship with the first company. Consequently, even if information on the first company itself is insufficient as the information for determining the creditworthiness, the determination device 100 can determine the creditworthiness of the first company by using the information on the second company that has a relationship with the first company.

Furthermore, the determination device 100 performs the determination process by using the account information that is held in the financial institution and that indicates high potential companies even if the companies are small in scale. Consequently, the determination device 100 can extract, as a borrower, an inconspicuous company such as a company that is not usually regarded as a borrower by a financial institution. Furthermore, if such an inconspicuous company is a company that actually has a transaction with a large enterprise or a company that increases its transaction with a trusted enterprise, the determination device 100 can exhibit, via, for example, the graph W10, the information to the financial institution such that the subject company is visibly conspicuous. In this way, an advantage is provided in that the determination device 100 can appropriately extract the first company that becomes a borrower.

In the following, a determination system 1 including the determination device 100 and the determination device 100 will be described in more detail.

### 2. Configuration of Determination System

In the following, the configuration of the determination system 1 according to the embodiment will be described with reference to FIG. 2. FIG. 2 is a diagram illustrating a configuration example of the determination system 1 according to the embodiment. As illustrated in FIG. 2, the determination system 1 includes a user terminal 10, the financial institution terminal 20, the financial institution server 30, the content distribution server 40, and the determination device 100. The devices included in the determination system 1 are connected with each other via a network N (for example, the Internet), which is a communication network, so as to be capable of communicating in a wired or wireless manner. Furthermore, the number of each of the devices included in the determination system 1 illustrated in FIG. 2 is not limited to the example illustrated in FIG. 2. For example, a plurality of the user terminals 10 may also be included in the determination system 1.

The user terminal 10 is an information processing apparatus used by a user who browses the content of a web page or the like. For example, the user terminal 10 is a desktop personal computer (PC), a notebook PC, a mobile phone, such as a smart phone, a tablet terminal, or a personal digital assistant (PDA). For example, the user terminal 10 acquires a web page from the content distribution server 40 in accordance with the operation performed by the user and displays the acquired web page.

Furthermore, the user terminal 10 sends predetermined information to the content distribution server 40. For example, in a search service, the user terminal 10 sends the name of a company as a query to the content distribution server 40. Furthermore, in a review site or the like, the user terminal 10 sends a review related to the product provided by the company to the content distribution server 40.

The financial institution terminal 20 is an information processing terminal used by a financial institution. For example, the financial institution terminal 20 is a desktop PC, a notebook PC, or the like. For example, the financial institution terminal 20 displays the graph W10 provided from the determination device 100 in accordance with an operation performed by the staff in the financial institution. Furthermore, the financial institution terminal 20 sends a predetermined request to the determination device 100 while displaying the graph W10.

The financial institution server 30 is a server device used by the financial institution. For example, the financial institution server 30 holds the account information on the companies. Furthermore, the financial institution server 30 sends the account information to the determination device 100 in accordance with an acquisition request sent from the determination device 100.

The content distribution server 40 is a web server that distributes, to the user terminal 10, web pages included in a web site that provides various services. For example, the content distribution server 40 distributes, to the user terminal 10, the web pages including various kinds of information related to portal sites, news sites, auction sites, weather forecast sites, shopping sites, finance (stock price) sites, route search sites, map providing sites, travel sites, eating house introduction sites, social networking service (SNS) service sites, web blogs, or the like.

Furthermore, various kinds of data distributed from the content distribution server 40 to the user terminal 10 are, in practice, Hyper Text Markup Language (HTML) files, images, or the like that forms the web pages; however, in a description below, various kinds of data distributed from the content distribution server 40 to the user terminal 10 are sometimes be referred to as content.

Furthermore, the content distribution server 40 stores therein user behaviors in the network N. Here, the user behaviors in the network N means information sent from the user terminal 10 in accordance with the operation performed by the user when using the service provided from various web sites. For example, The user behaviors in the network N include an input of a search query in a search site, a purchase behavior in a shopping site, a post of a review from a user in a product evaluation site, or the like. Furthermore, the user behaviors also include, for example, sending and receiving messages in social networking service (SNS) sites, follow behaviors performed on other peoples, or the like.

Furthermore, in accordance with the acquisition request from the determination device 100, the content distribution server 40 sends, to the determination device 100 as evaluation information on the companies, information related to the user behaviors in the network N described above, information on index values (for example, stock prices or exchange) that effect on business.

The determination device 100 is, as described above, a server device that determines the creditworthiness of the first company based on the account information and the evaluation information. Furthermore, the determination device 100 creates the graph W10 indicating the determined creditworthiness and the relationship between the companies and provides the crated graph W10 to the financial institution terminal 20.

### 3. Configuration of Determination Device

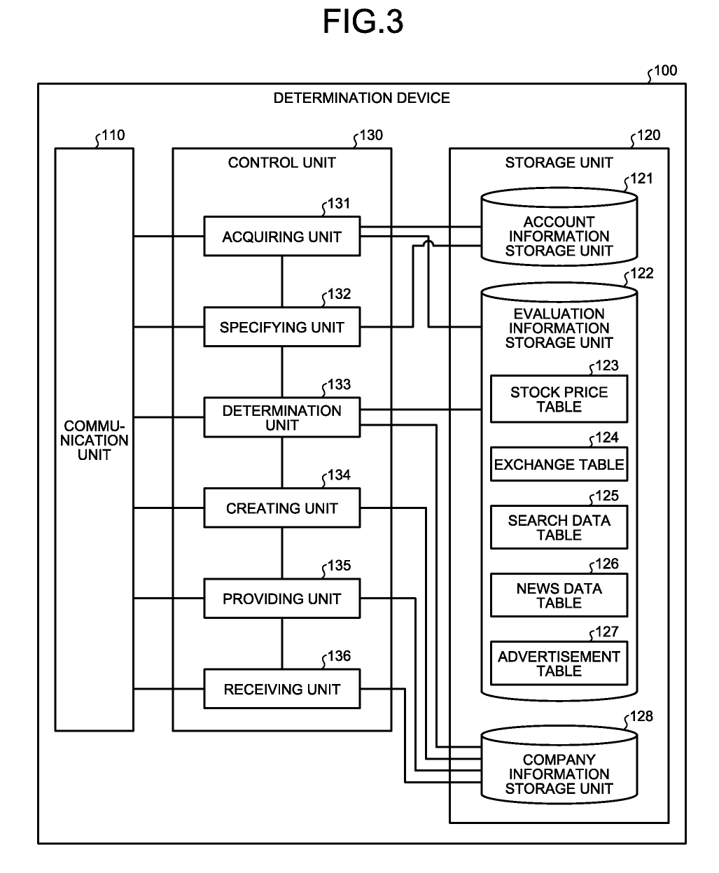

In the following, the configuration of the determination device 100 according to the embodiment will be described with reference to FIG. 3. FIG. 3 is a diagram illustrating a configuration example of the determination device 100 according to the embodiment. As illustrated in FIG. 3, the determination device 100 includes a communication unit 110, a storage unit 120, and a control unit 130. Furthermore, the determination device 100 may also include an input unit (for example, a keyboard, a mouse, etc.) that receives various operations from an administrator or the like who uses the determination device 100 and an output unit (for example, a liquid crystal display, etc.) that outputs various kinds of information. Communication Unit 110

The communication unit 110 is implemented by, for example, a network interface card (NIC), or the like. The communication unit 110 is connected to the network N in a wired or wireless manner and sends and receives information to and from the user terminal 10, the financial institution terminal 20, the financial institution server 30, the content distribution server 40 via the network N.

### Storage Unit 120

The storage unit 120 is implemented by, for example, a semiconductor memory device, such as a random access memory (RAM), a flash memory, or the like, or a storage device, such as a hard disk, an optical disk, or the like. The storage unit 120 according to the embodiment includes an account information storage unit 121, an evaluation information storage unit 122, and a company information storage unit 128. In the following, each of the storage units will be described.

### Account Information Storage Unit 121

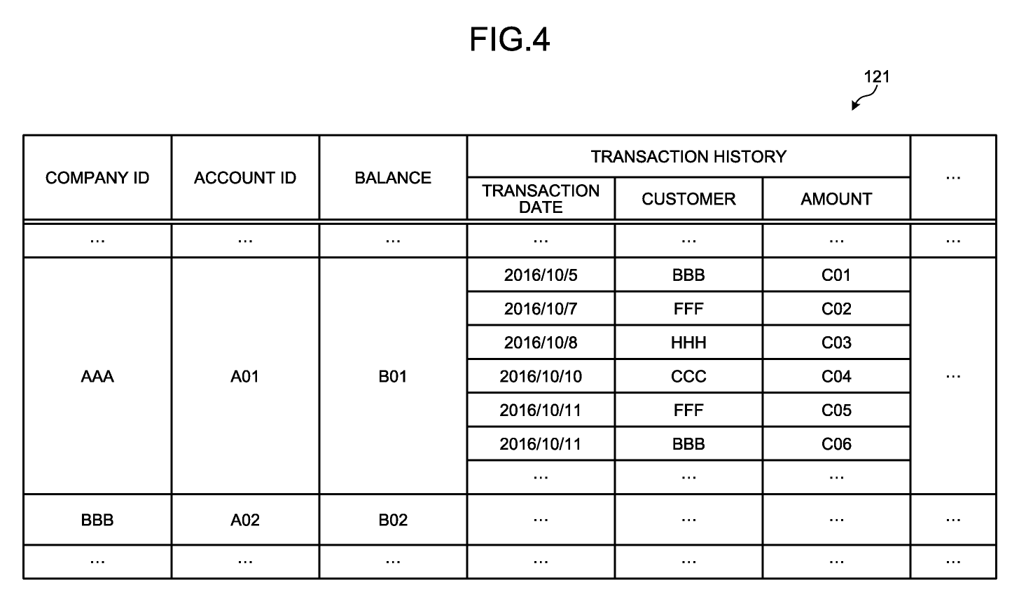

The account information storage unit 121 stores therein information related to accounts held by the companies. Here, an example of the account information storage unit 121 according to the embodiment is illustrated in FIG. 4. FIG. 4 is a diagram illustrating an example of the account information storage unit 121 according to the embodiment. As illustrated in FIG. 4, the account information storage unit 121 has items, such as a “company ID”, an “account ID”, a “balance”, a “transaction history”, and the like. Furthermore, the “transaction history” has small items, such as a “transaction date”, a “customer”, an “amount”, and the like.

The “company ID” indicates identification information for identifying the companies. In a description below, the identification information illustrated in FIG. 4 is sometimes used as reference numerals. For example, the company identified by a company ID “AAA” is sometimes referred to as a “company AAA”.

The “account ID” indicates identification information for identifying an account. The “balance” indicates a balance of the account. The “transaction history” indicates a history of a transaction stored in an account. The “transaction date” indicates the date of the transaction. The “customer” indicates a counterpart of the transaction. Furthermore, it is assumed that the company ID is used for information that indicates a customer. The “amount” indicates a transaction amount.

Furthermore, in the example illustrated in FIG. 4, the items of the “balance” and the “amount” are represented by the concept of “B01” and “C01”, respectively; however, in practice, the items of the “balance” and the “amount” store therein various kinds of information, such as a specific amount of a balance, a specific amount of a transaction, the type of deposit or payment, a category of an item of expenditure.

Namely, the example of the information illustrated in FIG. 4 indicates that the company AAA identified by the company ID “AAA” opens an account identified by an account ID “A01” and indicates that its balance is “B01”. Furthermore, as an example of the transaction history in the account A01, the example illustrated in FIG. 4 indicates that the transaction with an amount “C01” was conducted on a customer “BBB” on the transaction date “Oct. 5, 2016”.

### Evaluation Information Storage Unit 122

The evaluation information storage unit 122 stores therein information related to evaluation of companies. The evaluation information storage unit 122 includes, as a data table that stores therein information, a stock price table 123, an exchange table 124, a search data table 125, a news data table 126, and an advertisement table 127. In the following, each of the data tables will be described. Stock Price Table 123

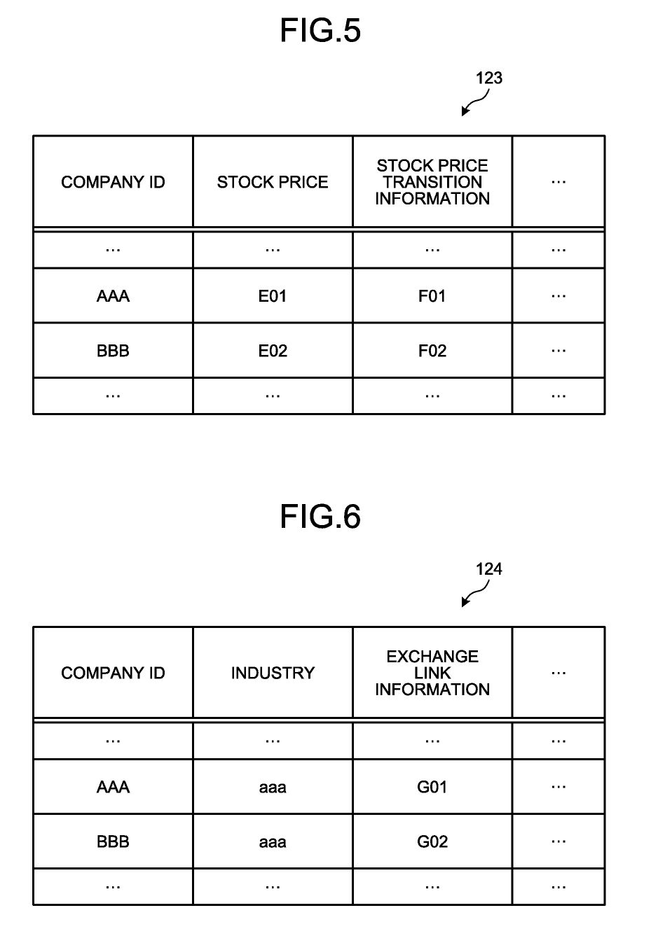

The stock price table 123 stores therein information related to stock prices. Here, an example of the stock price table 123 according to the embodiment is illustrated in FIG. 5. FIG. 5 is a diagram illustrating an example of the stock price table 123 according to the embodiment. As illustrated in FIG. 5, the stock price table 123 has items such as a “company ID”, a “stock price”, “stock price transition information”, and the like.

The “company ID” corresponds to the same item illustrated in FIG. 4. The “stock price” indicates a stock price at the time of acquisition. The “stock price transition information” indicates the transition of stock prices. Furthermore, in the example illustrated in FIG. 5, the items of the “stock price” and the “stock price transition information” are represented by the concept of “E01” and “F01”, respectively; however, in practice, the item of the “stock price” stores therein a specific numerical value of the stock price. Furthermore, the item of the “stock price transition information” stores therein, in addition to a specific numerical value of the stock price, information indicating a rise or a decline rate of a stock price in a predetermined time period, a difference with market movements (transition information indicating whether the stock of the subject company has risen in the face of a decline in price in the entire market), or the like. Furthermore, if the company is not able to acquire a stock price due to an unlisted enterprise, or the like or if information on a stock price is not present, the item of the “stock price” or the “stock price transition information” is blank.

Namely, the example of the information illustrated in FIG. 5 indicates that the stock price of the company AAA is “E01” and the stock price transition information is “F01”. Furthermore, the example illustrated in FIG. 5 indicates that the stock price of the company BBB having a relationship with the company AAA is “E02” and the stock price transition information is “F02”.

### Exchange Table 124

The exchange table 124 stores therein information related to exchange. Here, an example of the exchange table 124 according to the embodiment will be illustrated in FIG. 6. FIG. 6 is a diagram illustrating an example of the exchange table 124 according to the embodiment. As illustrated in FIG. 6, the exchange table 124 has items, such as a “company ID”, an “industry”, “exchange link information”, and the like.

The “company ID” corresponds to the same item illustrated in FIG. 4. The “industry” indicates an industry to which a company belongs. In the example illustrated in FIG. 6, the item of the “industry” is represented by the concept of “aaa” however, in practice, the item of the “industry” stores therein information indicating a specific industry, such as a steel industry, a household appliance industry, a communication industry, or the like. The “exchange link information” stores therein information related to the transition of performance linked with a movement of exchange. In the example illustrated in FIG. 6, the item of the “exchange link information” is represented by the concept of “G01”; however, in practice, the item of the “exchange link information” stores therein a specific numerical value indicating what kind of effect is applied to the business of the subject company or the entire industry in accordance with an movement of exchange or information indicating the general link relationships between the business engaged by the companies and exchange, such as information indicating, for example, that a strong yen is profitable for a company (industry), or the like.

Namely, the example of the information illustrated in FIG. 6 indicates that the industry to which the company AAA belongs is “aaa” and the exchange link information is “G01”. Search Data Table 125

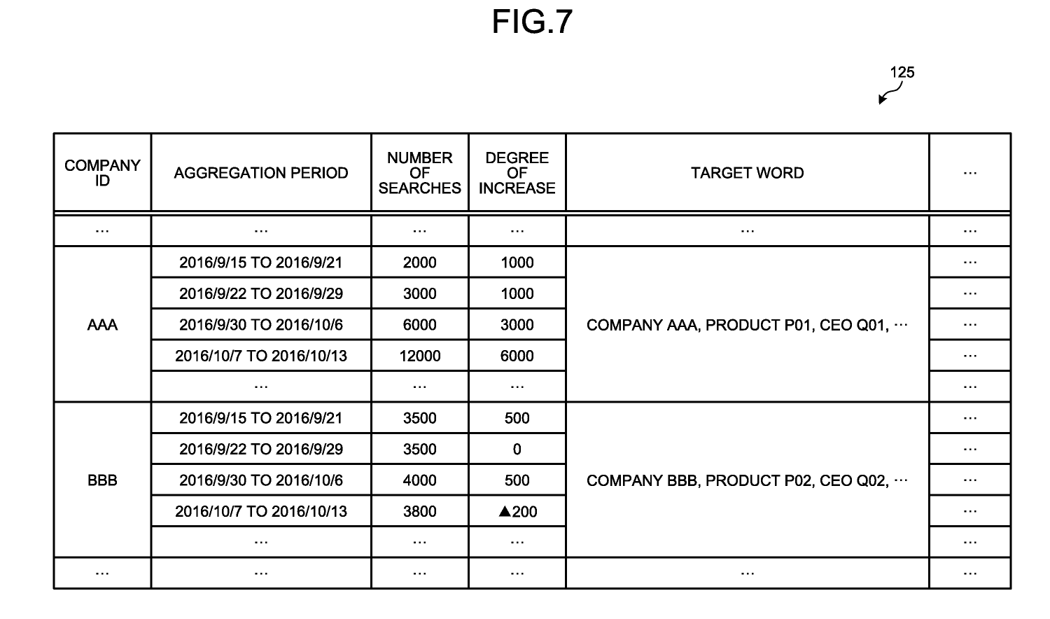

The search data table 125 stores therein information related to a search history indicating that a user searched for a company. Here, an example of the search data table 125 according to the embodiment is illustrated in FIG. 7. FIG. 7 is a diagram illustrating an example of the search data table 125 according to the embodiment. As illustrated in FIG. 7, the search data table 125 has items, such as a “company ID”, “aggregation period”, the “number of searches”, the “degree of increase”, a “target word”, and the like.

The “company ID” corresponds to the same item illustrated in FIG. 4. The “aggregation period” indicates a period of time for which information related to a search performed by a user is accumulated. In the example illustrated in FIG. 7, the aggregation period is one week; however, the aggregation period may also be a different period of time.

The “number of searches” indicates the number of times the company was searched for by a search engine in, for example, a predetermined search site. Furthermore, a search query that is counted as the number of searches is not limited to the name of the company itself but may also include the product name provided by the company, the name of the CEO of the company, or the like.

The “degree of increase” indicates a fluctuation value of the number of searches with respect to the number of searches obtained in the immediately previous aggregation period. The “target word” indicates the words to be counted as the number of searches related to a company when the one of the listed words are sent as a search query. For example, if the name recognition of the product name provided by a company is higher than the name of the company itself, it is conceivable that a user performs a search behavior by using the subject product name. In this case, even if a search has been performed by using a product name as a search query, if the product name is set in the target word, the number of searches for the company that provides the subject product is counted. The target word may also be manually set by an administrator of the determination device 100 or an application submitted by the company or may also be automatically set by, for example, analyzing the links of the web site based on the search result. Namely, when a user searches for a “product P01”, if a relatively large number of web sites related to the “company AAA” are displayed as the search result, the “product P01” is automatically set as the target word together with the company AAA.

Namely, the example of the information illustrated in FIG. 7 indicates that the company AAA is searched for in the aggregation period of “Sep. 15 to 21, 2016” “2000 times” and the degree of increase from the immediately previous number of searches is “1000 times”. Furthermore, the example in FIG. 7 indicates that, in the company AAA, the “company AAA”, the “product P01”, a “CEO Q01”, or the like are set as the target words.

Furthermore, in the search data table 125, information other than the information illustrated in FIG. 7 may also appropriately be stored. For example, the search data table 125 may also store therein information on a search ranking obtained based on the number of searches of each of the companies in the same industry, information on the search ranking obtained based on the degree of increase of the number of searches or the rate of the degree of increase of the number of searches, or the like. For example, as the order of the search rankings of a company increases, the company is evaluated to be a high performance company or a company that gains a lot of attention from users.

### News Data Table 126

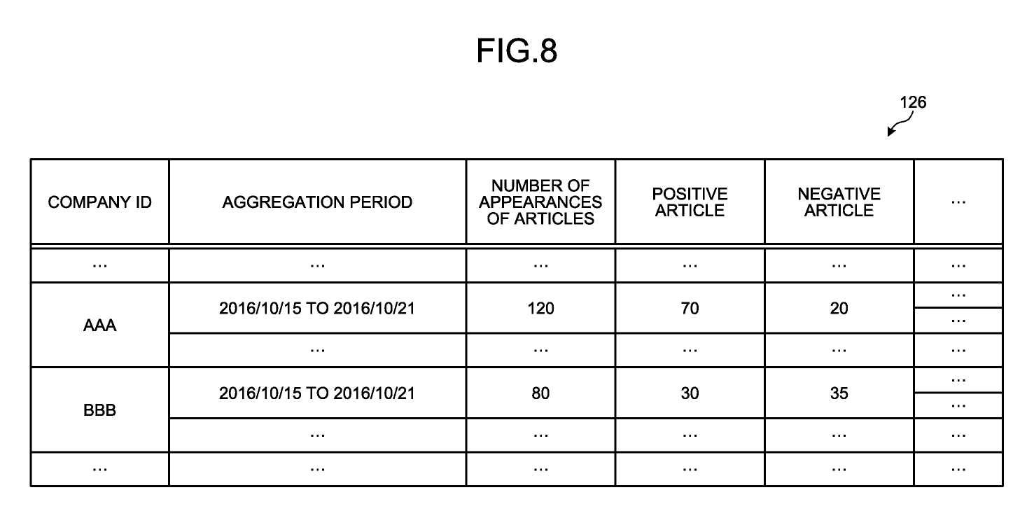

The news data table 126 stores therein information related to distribution articles about companies in predetermined news sites. Here, an example of the news data table 126 according to the embodiment is illustrated in FIG. 8. FIG. 8 is a diagram illustrating an example of the news data table 126 according to the embodiment. As illustrated in FIG. 8, the news data table 126 has items, such as a “company ID”, an “aggregation period”, the “number of appearances of articles”, a “positive article”, a “negative article”, and the like. Furthermore, the information stored in the news data table 126 may also be information collected from a plurality of news sites, instead of information collected from a single news site.

The “company ID” and the “aggregation period” correspond to the same items illustrated in FIG. 7. The “number of appearances of articles” indicates the number of articles that are distributed in an aggregation period and that are related to the companies.

The “positive article” indicates, from among the distributed articles, the article indicating a positive response with respect to a company (for example, corresponding to an article that introduces the products manufactured by the company, an article that informs of a favorable state of the company, an article that reports that the company was successfully listed on the stock exchange, or the like). The “negative article” indicates, from among the distributed articles, the article indicating a negative response with respect to a company (for example, corresponding to an article that informs of a defective product manufactured by the company, an article that informs of an unfavorable state of the company, an article that reports that the company was delisted).

Furthermore, determining whether an article is positive or negative may also be performed by using, for example, various known methods in combination. For example, the determination device 100 performs morphological analysis on text data included in news data; specifies the word indicating a company, the product name manufactured by the company, or the like; and counts the number of appearances of articles related to the company.

Furthermore, the determination device 100 determines the number of co-occurrences of the words indicating the company or the product name manufactured by the company and the words corresponding to general positive expressions or negative expressions or the ratio thereof. If the co-occurring positive expressions or negative expressions are observed by the number of times greater than a certain threshold, the determination device 100 determines whether the subject article is positive or negative. Furthermore, if the determination device 100 is unable to determine whether the article is positive or negative, the determination device 100 may also only determine the number of appearances of articles without determining whether the article is positive or negative.

Namely, the example of the information illustrated in FIG. 8 indicates that, in a news site, the company AAA appeared in the articles “120 times” in the aggregation period of “Oct. 15 to 21, 2016” and, from among the articles, the positive articles appeared “70” times and the negative articles appears “20” times.

Furthermore, in the news data table 126, information other than the information illustrated in FIG. 8 may also appropriately be stored. For example, the news data table 126 may also store therein information on a news ranking of the number of appearances of articles in the same industry, information on a news ranking based on the ratio of the degree of increase of the number of appearances of articles or the degree of increase of the number of appearances of articles, or the like. For example, as the order of news ranking or the ranking of positive articles about a company increases, the company is evaluated to be a high performance company or a company that gains a lot of attention from the general public.

### Advertisement Table 127

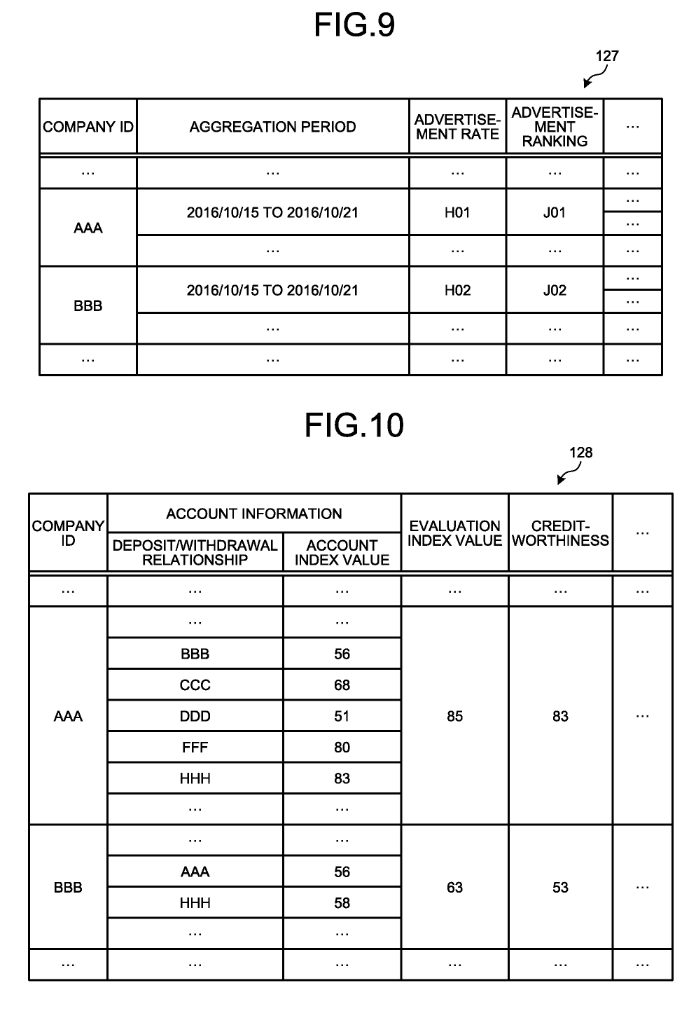

The advertisement table 127 stores therein information related to advertisements placed by the company. Here, an example the advertisement table 127 according to the embodiment is illustrated in FIG. 9. FIG. 9 is a diagram illustrating an example of the advertisement table 127 according to the embodiment. As illustrated in FIG. 9, the advertisement table 127 has items, such as a “company ID”, an “aggregation period”, an “advertisement rate”, an “advertisement ranking”, and the like.

The “company ID” and the “aggregation period” correspond to the same items illustrated in FIG. 8. The “advertisement rate” indicates the amount spent by the company on the advertisement. In FIG. 9, the item of the “advertisement rate” is represented by the concept of “H01”; however, in practice, the item of the “advertisement rate” stores therein an amount of the advertisement rate paid by the company, the type of the advertisement placed by the company, or the like. Furthermore, in a case of search advertising, a payment amount or a bid paid by the company with respect to a keyword (query) for displaying the advertisement is included.

The “advertisement ranking” indicates ranking information on the advertisement. In FIG. 9, the item of the “advertisement ranking” is represented by the concept of “J01”; however, in practice, the item of the “advertisement ranking” stores therein the type of advertisement placed by the company, an advertisement effect (a click rate, a conversion rate, etc.) of each advertisement, and information related to the ranking displayed on the search result in, for example, search advertising. In search advertising, the ranking of the advertisements to be displayed varies in accordance with, for example, an amount paid by an advertiser (company) to the keyword for displaying the advertisement. Consequently, it is assumed that the companies with a higher ranking in search advertising are the companies that correspondingly spend on the advertisement rate by that amount. As will be described later, in some cases, the determination device 100 determines the level of evaluation of the company based on this type of ranking information. Namely, the “advertisement ranking” mentioned here is the concept widely including not only the advertisement rankings but also advertisement effects and evaluation of advertisements related to the advertisement placed by the company.

Namely, the example of the information illustrated in FIG. 9 indicates that the company AAA spends an expense of “H01” as an advertisement rate in the aggregation period of “Oct. 15 to 21, 2016” and indicates that the advertisement ranking of the advertisement placed by the company AAA is “J01”.

### Company Information Storage Unit 128

The company information storage unit 128 stores therein information related to the companies. Here, an example of the company information storage unit 128 according to the embodiment is illustrated in FIG. 10. FIG. 10 is a diagram illustrating an example of the company information storage unit 128 according to the embodiment. As illustrated in FIG. 10, the company information storage unit 128 has items, such as a “company ID”, “account information”, an “evaluation index value”, “creditworthiness”, and the like. Furthermore, the “account information” has small items, such as a “deposit/withdrawal relationship”, an “account index value”, and the like.

The “company ID” indicates the same item illustrated in FIG. 4. The “account information” indicates information related to an account of a company. The “deposit/withdrawal relationship” indicates a company that has a deposit/withdrawal relationship with the subject company. Namely, the company that has a deposit/withdrawal relationship with the subject company mentioned here indicates the second company. The “account index value” is information indicating the evaluation of the company based on the account information is represented by a numerical value. As will be described in detail later, the account index value is calculated based on, for example, an evaluation value (a business scale, credibility, etc.) of the company itself that has the deposit/withdrawal relationship, the size of a transaction amount in the account, the size of the number of transactions, the transition of the transaction amount, or the like. In the example illustrated in FIG. 10, the account index value is obtained by normalizing the evaluation value related to the second company calculated based on the information on the transaction carried out between the second company and the first company, the evaluation information on the second company, or the like so as to be represented by the numerical values of 0 to 100.

The “evaluation index value” indicates information related to the evaluation of the company itself. For example, the evaluation index value is a numerical value calculated based on each of the pieces of information stored in the evaluation information storage unit 122. In the example illustrated in FIG. 10, the evaluation index value is obtained by normalizing the evaluation value related to the first company calculated based on the evaluation information on the first company so as to be represented by the numerical values of 0 to 100.

The “creditworthiness” indicates the creditworthiness as a borrower. In the example illustrated in FIG. 10, the creditworthiness is obtained by normalizing the numerical value calculated based on the account index value of the company that becomes the processing target and based on the value of the evaluation index value so as to be represented by the numerical values of 0 to 100. For example, the creditworthiness indicates that 100 is the best company suitable for a borrower and indicates that 0 is the worst company suitable for a borrower.

Namely, the example of the information illustrated in FIG. 10 indicates that, as the account information of the company AAA, the companies having a deposit/withdrawal relationship are a “company BBB”, a “company CCC”, a “company DDD”, a “company FFF”, and a “company HHH”. Furthermore, if the company AAA is assumed to be the first company, the account index value of the “company BBB” as the second company is “56” and the account index value of the “company CCC” is “68”, the account index value of the “company DDD” is “51”, the account index value of the “company FFF” is “80”, and the account index value of the “company HHH” is “83”. Furthermore, the example illustrated in FIG. 10 indicates that the evaluation index value of the company AAA is “85”. Furthermore, the example illustrated in FIG. 10 indicates that the creditworthiness of the company AAA as a borrower is “83”.

Furthermore, the example illustrated in FIG. 10 indicates a case in which the values of the creditworthiness or the like are normalized to the numerical values of 0 to 100; however, the example is not limited to this. For example, the determination device 100 may also represent the values of the creditworthiness or the like as arbitrary numerical values.

### Control Unit 130

A description will be continued by referring back to FIG. 3. The control unit 130 is a controller and is, for example, implemented by, for example, a central processing unit (CPU), a micro processing unit (MPU), or the like, executing various kinds of programs (corresponding to an example of a determination program), which are stored in an internal storage device in the determination device 100, by using a RAM as a work area. Furthermore, the control unit 130 is a controller and is implemented by, for example, an integrated circuit, such as an application specific integrated circuit (ASIC), a field programmable gate array (FPGA), or the like.

The control unit 130 according to the embodiment includes, as illustrated in FIG. 3, an acquiring unit 131, a specifying unit 132, a determination unit 133, a creating unit 134, a providing unit 135, and a receiving unit 136 and implements or performs the function or the operation of the information processing described below. Furthermore, the internal configuration of the control unit 130 is not limited to the configuration illustrated in FIG. 3 and another configuration may also be used as long as the configuration in which the information processing, which will be described later, is used. Furthermore, the connection relation between the processing units included in the control unit 130 is not limited to the connection relation illustrated in FIG. 3 and another connection relation may also be used.

### Acquiring Unit 131

The acquiring unit 131 acquires various kinds of information. For example, the acquiring unit 131 acquires the account information that is the information related to an account opened by the first company and the evaluation information that is the information related to evaluations of companies.

For example, the acquiring unit 131 acquires, as the account information, the information related to the second company that has a deposit/withdrawal relationship with the first company. For example, as the information related to the deposit/withdrawal transaction between the first company and the second company, the acquiring unit 131 acquires at least one of the transaction amount between the first company and the second company, the number of transactions, the transaction frequency, the transition of transaction amount, the transition of the number of transactions, and the transition of the transaction frequency. The acquiring unit 131 stores the acquired information in the account information storage unit 121.

Furthermore, as an example of the evaluation information, the acquiring unit 131 acquires the stock price information related to a company. For example, the acquiring unit 131 acquires the stock price information from the content distribution server 40 that has information on the stock market in which the company is listed. Furthermore, the acquiring unit 131 may also acquire, as the stock price information related to the company, the stock price information on a company related to the company. For example, the acquiring unit 131 acquires the stock price information on a company that has capital ties with the first company that is the processing target.

Furthermore, the acquiring unit 131 acquires the exchange information in an economic bloc to which the company belongs. The exchange information in the economic bloc to which the company belongs mentioned here corresponds to the exchange information on the relationship between, for example, if the company runs business in yen, the country in which yen is in circulation and the other countries. Furthermore, the acquiring unit 131 acquires exchange transition information indicating whether there is a possibility that the performance of the company is changed in connection with the exchange information. For example, the acquiring unit 131 previously receives, from an administrator or the like of the determination device 100, the setting of information on the companies or the industries whose performance is increased due to a strong yen or the companies or the industries whose performance is increased due a weak yen. Then, the acquiring unit 131 acquires, based on the set information, the industry or the category of business to which the first company that is the processing target and the second company belong.

Furthermore, the acquiring unit 131 acquires search data related to a company as the evaluation information. For example, the acquiring unit 131 acquires, from the content distribution server 40 that provides the search service, the type of search query sent from the user terminal 10, the number of queries sent, or the like.

Furthermore, the acquiring unit 131 acquires the information content data related to a company as the evaluation information. An example of the information content data is an article, such as, news data. For example, the acquiring unit 131 acquires the number of news articles reported about the company from the content distribution server 40 that provides a news service.

Furthermore, the acquiring unit 131 acquires information content data positive for the company or information content data negative for the company. For example, from among the articles distributed by the content distribution server 40 that provides the news service, the acquiring unit 131 acquires the number of news articles in which positive information about the company is described or negative information about the company is described.

Furthermore, the acquiring unit 131 acquires, as the evaluation information, information related to the advertisement placed by the company. For example, the acquiring unit 131 acquires the amount of the advertisement rate spent on the advertisement by the company. Furthermore, the acquiring unit 131 acquires information related to search advertising placed by the company. For example, the acquiring unit 131 acquires an advertisement fee (a bid amount of a keyword) related to the search advertising placed by the company or the listed ranking of the search advertising.

Furthermore, the acquiring unit 131 may acquire the evaluation information on either the first company or the second company. The acquiring unit 131 stores the acquired information in the evaluation information storage unit 122.

Furthermore, in the example illustrated in FIG. 1 indicates a case in which the acquiring unit 131 acquires various kinds of information from the content distribution server 40; however, the acquisition destination of the information is not limited to the content distribution server 40. For example, the acquiring unit 131 may also acquire the evaluation information from the user terminal 10. Furthermore, the acquiring unit 131 may also acquire the evaluation information from not only the user terminal 10 or the content distribution server 40 but also a predetermined external server. For example, the acquiring unit 131 may also acquire information from a cloud server or the like that accumulates the information related to the user terminal 10 or the content distribution server 40.

### Specifying Unit 132

The specifying unit 132 specifies the second company having a business relationship with the first company based on the account information acquired by the acquiring unit 131.

Specifically, based on the transaction history of the first company, the specifying unit 132 specifies the company having a deposit/withdrawal relationship as the second company. Furthermore, the specifying unit 132 may also specify, from among the companies having the deposit/withdrawal relationship, a predetermined number of companies as the second company. For example, the specifying unit 132 may also specify, as the second company, the predetermined number of companies in descending order of the transaction amount or the number of transactions of the first company.

### Determination Unit 133

The determination unit 133 determines the creditworthiness of the first company as a borrower based on the evaluation information related to the second company specified by the specifying unit 132.

Specifically, the determination unit 133 determines the creditworthiness of the first company based on the stock price information related to the second company. For example, if the stock price of the second company is on an upward trend, the determination unit 133 determines that the performance of the second company is favorable and thus the second company is a credible company. Then, the determination unit 133 determines that the creditworthiness of the first company that has a business relationship with such a credible second company is relatively high.

Furthermore, the determination unit 133 determines the creditworthiness of the first company based on the relationship between the industry to which the second company belongs and exchange. For example, if the industry to which the second company belongs is an industry that is favorable at the time of strong yen and if the current exchange information indicates a strong yen, because the performance of the second company is highly likely to be favorable, the determination unit 133 determines that such a second company is a credible company. Then, the determination unit 133 also determines that the creditworthiness of the first company that has a business relationship with such a credible second company is relatively high.

Furthermore, the determination unit 133 determines the creditworthiness of the first company based on the search data related to the second company. For example, if the products manufactured by the second company and the second company are frequently searched by users, because the second company receives attention from the users and the performance is highly likely to be favorable in the future, the determination unit 133 determines that the second company is a credible company. Then, the determination unit 133 also determines that the creditworthiness of the first company that has a business relationship with such a credible second company is relatively high.

Furthermore, the determination unit 133 determines the creditworthiness of the first company based on the information content data related to the second company. For example, the determination unit 133 determines the creditworthiness of the first company based on the information content data positive for the second company or the information content data negative for the second company. For example, if the second company and the products manufactured by the second company are frequently published in news articles, because the second company receives attention from the users and the performance is highly likely to be favorable in the future, the determination unit 133 determines that the second company is a credible company. Then, the determination unit 133 also determines that the creditworthiness of the first company that has a business relationship with such a credible second company is relatively high. Alternatively, if the number of negative article about the second company is large, because the performance is highly likely to be unfavorable, the determination unit 133 may also determine that the second company is not a credible company. Then, the determination unit 133 determines the creditworthiness of the first company that has a business relationship with such an untrustworthy second company.

Furthermore, the determination unit 133 determines the creditworthiness of the first company based on the information related to the advertisement placed by the second company. For example, the determination unit 133 determines the creditworthiness of the first company based on the advertisement fee or the advertisement ranking related to the search advertising placed by the second company. For example, if the advertisement fee spent by the second company is relatively high and the situation in which the second company actively invests in advertisements is observed, because the performance of the second company is favorable, the determination unit 133 determines that the second company is a credible company. Then, the determination unit 133 also determines that the creditworthiness of the first company that has a business relationship with such a credible second company is relatively high.

Furthermore, after having individually determined each of the pieces of evaluation information described above, the determination unit 133 may also calculate an index value (for example, corresponding to the “account index value” illustrated in FIG. 10) obtained by comprehensively evaluating the second company. Furthermore, such an index value is calculated by taking into account the information, such as the amount, the frequency, or the like with the first company. Then, the determination unit 133 determines the creditworthiness of the first company as the comprehensive result based on the calculated account index value.

Furthermore, in addition to the evaluation information related to the second company, the determination unit 133 may also determine the creditworthiness of the first company as a borrower based on the evaluation information related to the first company. For example, the determination unit 133 calculates the index value (for example, corresponding to the “evaluation index value” illustrated in FIG. 10) obtained by evaluating the first company by using each of the pieces of evaluation information described above. In this case, the determination unit 133 determines the creditworthiness of the first company as the comprehensive result based on the account index value and the evaluation index value described above.

Furthermore, the determination unit 133 may also perform a determination process by using information unique to the first company. For example, if the account balance of the first company increases above a predetermined ratio in a predetermined time period, the determination unit 133 may also determine that the creditworthiness of the first company is high.

Furthermore, based on various known methods, the determination unit 133 may also represent the evaluation information by a numerical value or may also perform a process of calculating the creditworthiness. For example, regarding the number of pieces of search data or the number of news articles, the determination unit 133 may also use a numerical value (evaluation value) normalized based on the relationship with overall statistical data. Furthermore, the determination unit 133 may also receive, from an administrator of the determination device 100, a setting of calculation information indicating, for example, an evaluation value that is to be added and that is associated with a rise in a stock price. In this case, the determination unit 133 may also calculate the account index value of the second company based on both an event (a rise in the stock price of the second company, etc.) acquired by the acquiring unit 131 and the numerical value to be added when the event occurs.

Furthermore, the determination unit 133 further determines the creditworthiness of the first company based on the information related to the deposit/withdrawal transaction between the second company specified by the specifying unit 132 and the first company. Specifically, the determination unit 133 determines the creditworthiness of the first company based on, as the information related to the deposit/withdrawal transaction, at least one of the transaction amount between the first company and the second company, the number of transactions, the transaction frequency, the transition of the transaction amount, the transition of the number of transactions, and the transition of the transaction frequency. In this case, based on the regression analysis using predetermined correct answer data, the determination unit 133 may also determine the information related to each of the deposit/withdrawal transactions or the numerical value associated with the evaluation information. For example, regarding the listed companies, the numerical values obtained by evaluating the companies based on, for example, the financial information on the companies are sometimes released by an external institution (an institution that investigates and evaluates companies). The determination unit 133 performs the regression analysis by using the evaluation values as correct answer data (response variables) and by using pieces of information, such as the information on the stock prices, the search data, the deposit/withdrawal transactions, and the like, as elements (explanatory variables). Then, the determination unit 133 may also calculate an evaluation value of the second company by using the regressively derived model and may also further determine the creditworthiness of the first company based on the calculated value. For example, the determination unit 133 creates the regression expression (1) below.

Y=α1·x1+α2·x2+α3·x3+ . . . +αn·xn (1)

In Expression (1) above, for example, an evaluation value calculated by an external institution or correct answer data that is set by an administrator of the determination device 100 is input to “Y”. Furthermore, a variable obtained by converting, for example, each of a stock price, exchange, search data, news data, and advertisement data, to numerical values based on a predetermined reference (for example, information obtained by digitizing the number of searches, the number of articles, the advertisement rate, the advertisement ranking, or the like so as to be compared with each other) is input to “x1 to xn” (n is an arbitrary number). Furthermore, when an evaluation value of the second company is calculated, the account information (the transaction amount with the first company, the number of transactions, the transition of the transaction amount, etc.) may also be input. By performing learning by using Expression (1) above (i.e., regressively calculating a sufficient number of samples), the determination unit 133 optimizes the value of “αn” associated with each of the items. Namely, when calculating, for example, an evaluation value of the second company, the determination unit 133 obtains a value of the weighting value “an” indicating how much effect has the magnitude of the “number of searches” on the score. Then, the determination unit 133 sets the obtained weighting value and creates a model.

Furthermore, the model described above is an example and the model created by the determination unit 133 is not limited to the example described above. Namely, the determination unit 133 may also appropriately create a model different from the example described above by combining known methods as long as a model in which the evaluation information or the account information (a transaction amount or the number of transactions) is input and a value indicating the evaluation value of the company is output is used. For example, in the example described above, a case in which a model is created by using the regression analysis is indicated; however, the determination unit 133 may also create the model by using another statistical process.

### Creating Unit 134

The creating unit 134 creates the graph W10 indicating the relationship between the first company and the second company based on the deposit/withdrawal relationship between the first company and the second company and the creditworthiness of the first company that is determined by the determination unit 133.

For example, the creating unit 134 may also create the graph W10 in which the relationship is more visually emphasized as the transaction amount between companies is greater in the deposit/withdrawal relationship. The creating unit 134 creates, as illustrated in, for example, FIG. 1, the graph W10 in which the line connecting the companies is emphasized by the thicker lines as the transaction amount between the companies is greater in the deposit/withdrawal relationship.

Furthermore, the creating unit 134 may also create the graph W10 in which the relationship is more visually emphasized as the transition of the transaction amount between the companies in a predetermined time period is greater in the deposit/withdrawal relationship. Namely, the creating unit 134 may also create the graph W10 in which the line connecting the companies is emphasized by the thicker lines as the transition of the transaction amount between the companies in a predetermined time period is greater. In this case, because the visual display of the graph W10 is changed due to the amount of the recent transaction rather than the magnitude of the absolute value of the actual transaction amount, the graph W10 in which, for example, the first company that rapidly increases its performance (transactions) is highly visible.

Furthermore, the creating unit 134 may also create the graph W10 in which the relationship is more visually emphasized as the period of the business relationship between the companies is longer in the deposit/withdrawal relationship. Namely, the creating unit 134 may also create the graph W10 in which the line connecting the companies is emphasized by the thicker lines as the period of the business relationship between the companies is longer. For example, a certain trust relationship is presumed between the companies that have a business relationship for a long time. Consequently, by creating the graph W10 in which the companies having the business relationship for a long time is more emphatically displayed than the companies having a business relationship for a sort time, the creating unit 134 can exhibit, to the financial institution, the transition indicating what kind of relationship has been built with the second company by the first company.

Furthermore, the creating unit 134 may also create the graph W10 in which the size of the node associated with the first company is changed in accordance with the creditworthiness of the first company. For example, as illustrated in FIG. 1, the creating unit 134 may also create the graph W10 by setting the rank associated with the creditworthiness to the node and displaying the node with the size associated with the set rank. For example, regarding the creditworthiness determined by the determination unit 133, the creating unit 134 may also create the graph W10 in which the companies with the value “80” and or more are set to be the highest ranked node, the companies with the value between or equal to “60” and “79” are set to be the medium ranked nodes, and the companies with the value “59” or less are set to be the lowest ranked nodes.

Furthermore, if the creating unit 134 receives a request for selection of a predetermined first company from the receiving unit 136, which will be described later, the creating unit 134 may also newly create the graph W10 indicating the relationship between the predetermined first company and the second company by using the predetermined first company as the reference point. For example, the financial institution side sometimes browses the graph W10 created by the creating unit 134 for the first time and select an interested company. In this case, the creating unit 134 newly creates the graph W10 based on the selected company as the first company. Consequently, the creating unit 134 can create the graph W10 indicating the relationship focusing on the first company desired by the financial institution side.

### Providing Unit 135

The providing unit 135 provides the graph W10 created by the creating unit 134. Specifically, the providing unit 135 provides the graph W10 to the financial institution in a manner in which the financial institution terminal 20 can display the graph W10.

Furthermore, if the providing unit 135 receives, by the receiving unit 136 from the financial institution terminal 20, a request when, as a trigger, the operation of selecting the first company displayed on the financial institution terminal 20 is performed, the providing unit 135 provides the newly created graph W10 by using the selected company as the reference point. In this case, in the graph W10 displayed on the financial institution terminal 20, the providing unit 135 may also display the graph W10 that is newly created in real time on the screen of the financial institution terminal 20 when, as a trigger, the first company is selected by a pointer or the like.

Furthermore, if the providing unit 135 receives, by the receiving unit 136 from the financial institution terminal 20, a request when, as a trigger, the operation of selecting the line connecting the companies displayed on the financial institution terminal 20 is performed, the providing unit 135 may also provide the information indicating the connection between the companies connected by the line. Specifically, if the providing unit 135 receives, by the receiving unit 136, a request when, as a trigger, the operation of selecting the line connecting the companies is performed, the providing unit 135 may also provide the information on the capital ties or the like related to the two companies connected by the line.

### Receiving Unit 136

The receiving unit 136 receives various requests. For example, the receiving unit 136 receives a request for an offer to provide the graph W10 from the financial institution terminal 20. If the receiving unit 136 receives such a request, the providing unit 135 provides the created graph W10 to the financial institution terminal 20.

Furthermore, regarding the graph W10 provided to the financial institution terminal 20, the receiving unit 136 receives various requests via the graph W10. For example, the receiving unit 136 receives a request sent from the financial institution terminal 20 when, as a trigger, an operation of selecting the company displayed on the financial institution terminal 20 is performed. For example, if the first company is newly selected, the receiving unit 136 receives the request for newly creating the graph W10 by using the selected first company as the reference point.

Furthermore, if the receiving unit 136 receives, from the financial institution terminal 20, a request when, as a trigger, the operation of selecting the line connecting the companies displayed on the financial institution terminal 20, the receiving unit 136 may also receive a request for an offer to provide the information indicating the connection between the companies connected by the line.

### 4. Flow of Processes

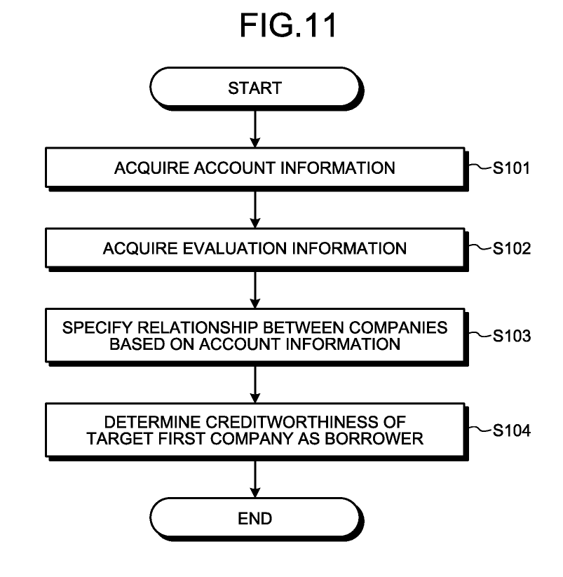

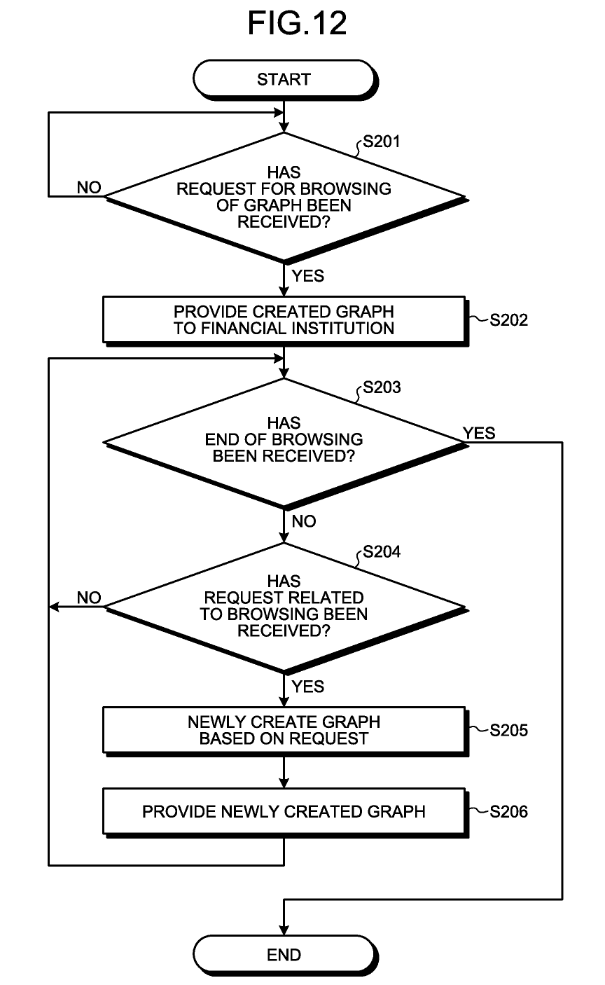

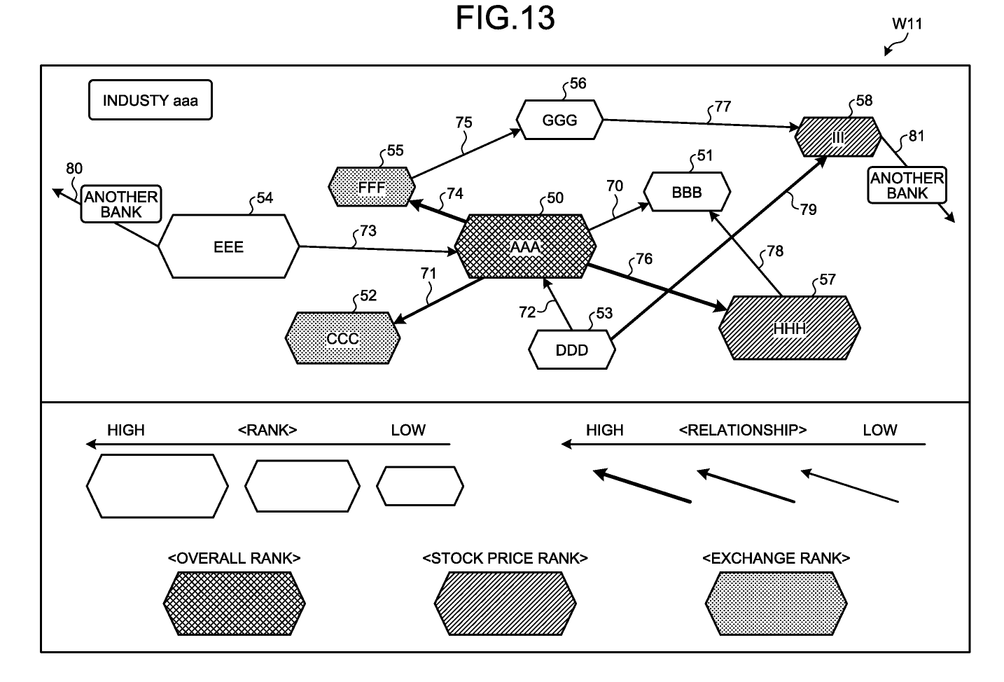

In the following, the flow of the processes performed by the determination device 100 according to the embodiment will be described with reference to FIGS. 11 and 12. First, the flow of the determination process according to the embodiment will be described with reference to FIG. 11. FIG. 11 is a flowchart (1) illustrating the flow of the process according to the embodiment.

As illustrated in FIG. 11, the determination device 100 acquires the account information from the financial institution server 30 (Step S101). Furthermore, the determination device 100 acquires the evaluation information related to the companies from the content distribution server 40 (Step S102).

Then, the determination device 100 specifies the relationship between the companies based on the account information (Step S103). Specifically, the determination device 100 specifies the second company having a relationship with the first company.

Then, based on the account information and the evaluation information on the specified second company, the determination device 100 determines the creditworthiness of the target first company as a borrower (Step S104).

In the following, a providing process according to the embodiment will be described with reference to FIG. 12. FIG. 12 is a flowchart (2) illustrating the flow of the process according to the embodiment.

As illustrated in FIG. 12, the determination device 100 determines whether a request for browsing of the graph W10 has been received from the financial institution terminal 20 (Step S201). If the request for browsing of the graph W10 has not been received (No at Step S201), the determination device 100 waits until the determination device 100 receives the request.

In contrast, if the request for browsing of the graph W10 has been received (Yes at Step S201), the determination device 100 provides the created graph W10 to the financial institution (Step S202).

After the graph W10 is displayed on the financial institution terminal 20, the determination device 100 determines whether the end of browsing of the graph W10 has been received from the financial institution terminal 20 in an arbitrary timing (Step S203). Furthermore, the end of browsing of the graph W10 mentioned here means that, for example, the browser software or the like that displays the graph W10 on the financial institution terminal 20 side is closed. If the end of browsing of the graph W10 has been received (Yes at Step S203), the determination device 100 ends the providing process.

In contrast, if the end of browsing of the graph W10 has not been received (No at Step S203), the determination device 100 waits to receive a predetermined request from the financial institution terminal 20. Namely, the determination device 100 determines, via the graph W10, whether a request related to the browsing of the first company or the like that is newly used as the reference point has been received (Step S204). If the first company that is newly used as the reference point has not been received (No at Step S204), the determination device 100 waits to receive a predetermined request from the financial institution terminal 20.

In contrast, if the first company that is newly used as the reference point has been received (Yes at Step S204), the determination device 100 newly creates the graph W10 based on the request (Step S205). Specifically, the determination device 100 again creates the graph W10 by using the received first company as the reference point. Then, the determination device 100 provides the newly created graph W10 to the financial institution terminal 20 (Step S206). This process may also be performed in a seamless manner via the graph W10 on the screen of the financial institution terminal 20. The determination device 100 repeats the process until the end of browsing is received from the financial institution terminal 20.

### 5. Modification

The determination system 1 according to the embodiment described above may also be performed with various kinds of embodiments other than the embodiment described above. Therefore, another embodiment of the determination system 1 will be described below.

### 5-1. Display of Node

In the embodiment described above, an example has been described in which, as illustrated in FIG. 1, the determination device 100 creates the graph W10 in which the node with the size in accordance with the rank of the creditworthiness is displayed or the thickness of the lines are changed in accordance with the magnitude of the transaction amount. Here, the determination device 100 may also create a graph by further adding a display technique in order to increase the visibility. This point will be described with reference to FIG. 13.

FIG. 13 is a diagram illustrating an example of a creating process according to a modification. FIG. 13 illustrates the graph W11 created by the determination device 100 according to the modification.

For example, from among the companies included in the graph W11, the determination device 100 displays the top two companies that are in a favorable stock price situation or the top two companies that are assumed to be better in the performance in accordance with the exchange situation by adding a color. The companies that are in a favorable stock price situation mentioned here are, for example, the companies of which stock price is high or the companies in which the rate of increase in stock prices is high. Furthermore, the companies that are assumed to be better in the performance in accordance with the exchange situation mentioned here are, for example, the companies that conduct business that is assumed to be susceptible in the current exchange situation, i.e., a stronger yen.

For example, it is assumed that the determination device 100 determines that the companies associated with the node 57 and the node 58 are the top two companies that are in a favorable stock price situation from among the companies included in the graph W11. In this case, as illustrated in FIG. 13, the determination device 100 displays the node 57 and the node 58 by adding the color. Furthermore, it is assumed that the determination device 100 determines that the companies associated with the node 52 and the node 55 are the top two companies that are assumed to be better in the performance in accordance with the exchange situation from among the companies included in the graph W11. In this case, as illustrated in FIG. 13, the determination device 100 displays the node 52 and the node 55 by adding a color different from a color added to the node 57 and the node 58.

Furthermore, the determination device 100 may also display, from among the companies included in the graph W11, the company having the highest creditworthiness by adding a color. For example, it is assumed that the determination device 100 determines that the company associated with the node 50 is the company having the highest creditworthiness from among the companies included in the graph W11. In this case, as illustrated in FIG. 13, the determination device 100 displays the node 50 by adding a color different from the color added to the node 52 and the node 55 or the color added to the node 57 and the node 58.

In this way, the determination device 100 may also create the graph W11 in which the color of the nodes is changed in accordance with the evaluation information or the account information. Consequently, the determination device 100 can exhibit, to the financial institution side that uses the graph W11 in an easily comprehensible manner, which of the company associated with the node is to be a noteworthy company.

### 5-2. Display of Line

The determination device 100 may also create the graph W11 in which the visibility is further increased. For example, the determination device 100 may also create the graph W11 in which the distance of the line between the nodes is adjusted. For example, the determination device 100 may also adjust the distance of the line between the nodes in accordance with the transaction period of the companies. Specifically, the determination device 100 shortens the line between the nodes as the transaction period of the companies is longer. Consequently, because the determination device 100 can bring the nodes associated with the companies having the close trust relationship closer, the determination device 100 can create the graph W11 so as to easily and visually understand the trust relationship (transaction period) between the companies.

Furthermore, the determination device 100 may also perform visual adjustment by arranging the nodes such that the lines between the nodes do not intersect or the distances between the nodes that do not have direct transactions in terms of accounts are within a predetermined range.

Furthermore, when the determination device 100 acquires the account information from a plurality of financial institutions and creates the graph W11 extending over the plurality of financial institutions, the determination device 100 may also create the graph W11 in which the relationship between the financial institutions and the nodes are visually represented. For example, regarding the nodes having business with the same megabank, the determination device 100 may also create the graph W11 by arranging the nodes such that the distances between the nodes are within a predetermined range.

### 5-3. Reference Point

The determination device 100 may also select, in accordance with the request received from the financial institution terminal 20, the node that becomes the reference point. For example, it is assumed that the determination device 100 receives a search request related to a specific company from the financial institution terminal 20. In this case, the determination device 100 may also create the graph W11 by using the searched specific company as the reference point.

In this case, it is assumed that the searched specific companies are the relatively large-scale companies that are recognized by the financial institution. Consequently, it is assumed that the companies have many business relationships and, if all of the relationships are depicted in the graph W11, the visibility may possibly be impaired. Thus, the determination device 100 may also create the graph W11 in which the companies that have the relationship with the searched specific companies and the number of which is reduced to a predetermined number as the nodes. Furthermore, in this case, it is conceivable that the financial institution side has an intention to extract, rather than extracting the searched specific companies as borrowers, inconspicuous companies related to the searched specific companies as borrowers (the companies that are not assumed to be search targets to begin with). Consequently, the determination device 100 may also create the graph W11 in which the plurality of the first companies are emphatically displayed by using the searched companies as the second companies. By doing so, the financial institution side can receive the graph W11 that is useful when new borrowers are extracted.

Furthermore, the determination device 100 may also create the graph W11 in which the reference point is not particularly set. In this case, the determination device 100 may also create the graph W11 in which each of the nodes displayed in the graph W11 is more visually emphasized without distinguishing the first company from the second company as the creditworthiness of the company is higher.

### 5-4. Mode of Nodes

Furthermore, the determination device 100 may also create the graph W11 that excels in visibility. For example, the determination device 100 acquires, via the network N, image data with a logo of the company associated with each of the nodes. Then, the determination device 100 may also create the graph W11 in which each of the nodes is displayed by the logo. Consequently, the determination device 100 can create the easily recognizable graph W11 in which which company is associated with which node at a glance.

Furthermore, the determination device 100 may also create the graph W11 in which each of the nodes is associated with the relationship of the companies. For example, if the staff in the financial institution clicks a predetermined node in the graph W11 displayed on the financial institution terminal 20, the determination device 100 may also provide an interface for displaying, on a screen, the information on the company associated with the subject node. Furthermore, if the staff in the financial institution clicks a predetermined node, the determination device 100 may also provide an interface for allowing a search server to search for the information on the company associated with the subject node and displaying the searched result.

### 5-5. Example of Information Content

In the embodiment described above, the news data (article) is described as an example of the evaluation information; however, the example of the information content is not limited to this. For example, the determination device 100 may also use, for the process, text data sent by a user as the information content.

For example, the determination device 100 may also acquire user reviews or the like of the products of the company in review sites. Then, the determination device 100 acquires the number of user reviews of the products of the company and the evaluation indicating whether the reviews are positive or negative. Then, the determination device 100 may also calculate the index value related to the evaluation of the company related to the subject products in accordance with the number of reviews or the evaluation. For example, regarding a company of which product is bitterly criticized by a user in a review site, the determination device 100 may also determine that the potential of its business is threatened and perform adjustment such that the evaluation value and the creditworthiness are reduced.

Furthermore, the determination device 100 may also acquire comments of users as the information content from not only the review sites but also SNS or electronic bulletin boards.

### 5-6. Each Device in Determination System

Each of the devices included in the determination system 1 may also implemented by various modifications. For example, the determination device 100 may also perform the process performed by the content distribution server 40. Furthermore, the determination device 100 may also perform a process of providing the graph W11 to the web page provided by the content distribution server 40. Namely, the graph W11 may also be provided to the user terminal 10 as, for example, one of the pieces of the content displayed on a finance site. Furthermore, the financial institution terminal 20 and the financial institution server 30 may also be integrally formed.

### 5-7. Evaluation of Companies

The evaluation of the companies is not limited to the example described in the embodiment above but may also be determined based on various events. For example, the determination device 100 may also give a high evaluation with respect to making an initial public offering. Specifically, the determination device 100 may also determine that the creditworthiness of the first company having a relationship with the second company that made an initial public offering is high or determines that the creditworthiness of the first company that made an initial public offering is high.

Furthermore, the determination device 100 may also create the model described above by using, as the correct answer data, the company that made an initial public offering or the company that continue its business without any problem in a predetermined time period after the financial institution actually provided financing.

For example, the determination device 100 performs learning by using the companies that made an initial public offering or the companies that continue their business without problems as the correct answer data and by using the stock price transitions of their companies, the exchange information, the search data, the news data, the advertisement data, or the like as variables. Based on the learning performed in this way, if a stock price transition of a certain company, the exchange information, the search data, the news data, the advertisement data, or the like is input, the determination device 100 can create a model capable of outputting the index value indicating that the company will make an initial public offering in the future or the company possibly continues its business without problems. For example, the determination device 100 may also use the output index value as the account index value, the evaluation index value, or the numerical value of the creditworthiness described above.

### 5-8. External Institution Data

In the embodiment described above, an example has been described in which, when the creditworthiness of the first company is determined, the index value related to the evaluation of the second company is calculated. Here, regarding the index value related to the evaluation of the second company, the determination device 100 may also use data of an external institution. Namely, the determination device 100 acquires, as the evaluation information, a predetermined evaluation value obtained when the external institution evaluated the second company and determines, based on the acquired predetermined evaluation value, the creditworthiness of the first company.

For example, the determination device 100 uses the evaluation value released by the external institution that evaluates the company targeted for the listed enterprises or the like as the index value of the second company. Namely, the determination device 100 may also perform the determination process that uses evaluation values, such as generally released enterprise value data or enterprise asset data. In this way, by using the data of the external institution, the determination device 100 can give the credibility of the data to objective credibility and simplify the determination process.

### 6. Others

Of the processes described in the embodiment, the all or part of the processes that are mentioned as being automatically performed can also be manually performed, whereas the all or part of the processes that are mentioned as being manually performed can also be automatically performed using known methods. Furthermore, the flow of the processes, the specific names, and the information containing various kinds of data or parameters indicated in the above specification and drawings can be arbitrarily changed unless otherwise stated. For example, the various kinds of information illustrated in each of the drawings are not limited to the information illustrated in the drawings.

The components of each device illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions.

For example, the account information storage unit 121, the evaluation information storage unit 122, and the company information storage unit 128 illustrated in FIG. 3 may also be held by an external storage server or the like, instead of being held by the determination device 100. In this case, the determination device 100 acquires the account information, the information related to the evaluation information, and the like by accessing the storage server.

Furthermore, for example, the determination device 100 as described above may be separated into a front end server side that mainly performs operation with external devices to acquire the account information from the financial institution server 30 or to distribute evaluation information from the content distribution server 40 and a back end server side that mainly performs a process of determining the creditworthiness of a company, a process of creating a graph, and the like.

### 7. Hardware Configuration

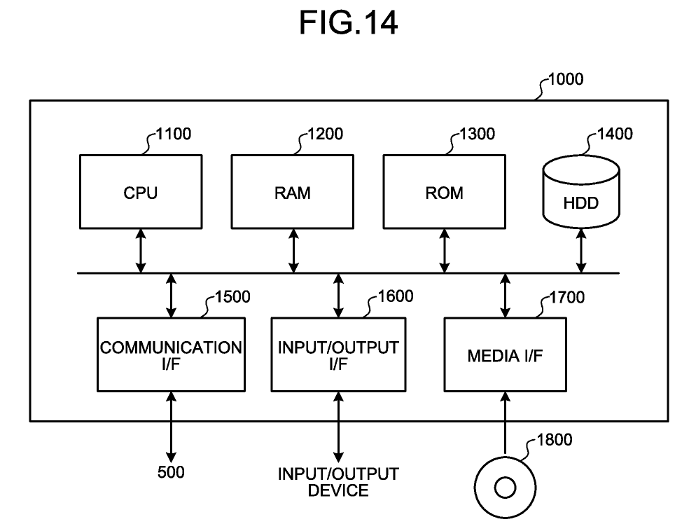

Furthermore, the determination device 100, the user terminal 10, the financial institution terminal 20, the financial institution server 30, and the content distribution server 40 according to the embodiment described above is implemented by a computer 1000 having the configuration illustrated in, for example, FIG. 14. In the following, a description will be given by using the determination device 100 as an example. FIG. 14 is a hardware configuration diagram illustrating an example of the computer 1000 that implements functions of the determination device 100. The computer 1000 includes a CPU 1100, a RAM 1200, a read only memory (ROM) 1300, a hard disk drive (HDD) 1400, a communication interface (I/F) 1500, an input/output interface (I/F) 1600, and a media interface (I/F) 1700.

The CPU 1100 operates based on a program stored in the ROM 1300 or the HDD 1400 and controls each of the units. The ROM 1300 stores therein a boot program that is executed by the CPU 1100 when the computer 1000 is started up, a program that depends on hardware of the computer 1000, or the like.

The HDD 1400 stores therein a program executed by the CPU 1100, data used by the program, or the like. The communication interface 1500 receives data from other devices via a communication network 500 (corresponding to the network N illustrated in FIG. 2), sends the data to the CPU 1100, and sends data generated by the CPU 1100 to other devices via the communication network 500.

The CPU 1100 controls an output device, such as a display or a printer, and an input device, such as a keyboard or a mouse, via the input/output interface 1600. The CPU 1100 acquires data from the input device via the input/output interface 1600. Furthermore, the CPU 1100 outputs the generated data to the output device via the input/output interface 1600.

The media interface 1700 reads a program or data stored in a recording medium 1800 and provides the program or the data to the CPU 1100 via the RAM 1200. The CPU 1100 loads the program from the recording medium 1800 into the RAM 1200 via the media interface 1700 and executes the loaded program. The recording medium 1800 is, for example, an optical recording medium, such as a digital versatile disc (DVD) or a phase change rewritable disk (PD), a magneto optical recording medium, such as a magneto-optical disk (MO), a tape medium, a magnetic recording medium, a semiconductor memory, or the like.

For example, when the computer 1000 functions as the determination device 100, the CPU 1100 of the computer 1000 implements the functions of the control unit 130 by executing the program loaded in the RAM 1200. Furthermore, the HDD 1400 stores therein the pieces of data stored in the storage unit 120. The CPU 1100 of the computer 1000 reads the program from the recording medium 1800 and executes the program. For another example, the program may also be acquired from other devices via the communication network 500.

### 8. Effects

As described above, the determination device 100 according to the embodiment includes the acquiring unit 131, the specifying unit 132, and the determination unit 133. The acquiring unit 131 acquires the account information that is the information related to a transaction of an account opened by the first company and acquires the evaluation information that is the information related to evaluations of companies. The specifying unit 132 specifies, based on the account information acquired by the acquiring unit 131, the second company that has a business relationship with the first company. The determination unit 133 determines the creditworthiness of the first company based on the evaluation information related to the second company specified by the specifying unit 132.

In this way, the determination device 100 according to the embodiment determines the creditworthiness of the first company as a borrower by using the evaluation information on the second company that has a business relationship with the first company. Thus, even if information on the first company itself is insufficient as the information used to determine the creditworthiness, the determination device 100 can determine the creditworthiness of the first company by using the information on the second company that has a relationship with the first company. Namely, even if the first company is small-scale and inconspicuous company or the first company has just been established, the determination device 100 can determine the creditworthiness of the first company as a borrower and thus appropriately extract the first company that becomes a borrower.

Furthermore, the acquiring unit 131 acquires the stock price information related to the second company as the evaluation information. The determination unit 133 determines the creditworthiness of the first company based on the stock price information related to the second company.

In this way, the determination device 100 according to the embodiment determines the creditworthiness of the first company based on the current stock price or the transition of the stock price of the second company. Consequently, the determination device 100 can accurately determine the creditworthiness conforming to the current economic situation.

Furthermore, the acquiring unit 131 acquires, as the evaluation information, the exchange information in the economic bloc to which the second company belongs. The determination unit 133 determines the creditworthiness of the first company based on the relationship between the industry to which the second company belongs and exchange.

In this way, the determination device 100 according to the embodiment determines the creditworthiness of the first company based on the current exchange situation, information linked with exchange used in the industry to which the second company belongs, or the like. Consequently, the determination device 100 can accurately determine the creditworthiness conforming to the current exchange situation.

Furthermore, the acquiring unit 131 acquires, as the evaluation information, the search data related to the second company. The determination unit 133 determines the creditworthiness of the first company based on the search data related to the second company.

Namely, the determination device 100 according to the embodiment may also determine the creditworthiness of the first company based on the number of searches, a rate of increase in searches, or the like. The search data can be used as the index value for measuring the degree of attention of general users. Thus, it is possible to determine that the second company that excels in the number of searches, the rate of increase in searches, or the like is a high potential company. Furthermore, it is also possible to determine that the first company that has a transaction with the second company is highly likely to be a potential company. In this way, the determination device 100 can determine the creditworthiness of the first company from various points of view.

Furthermore, the acquiring unit 131 acquires, as the evaluation information, the information content data related to the second company. The determination unit 133 determines the creditworthiness of the first company based on the information content data related to the second company.

In this way, the determination device 100 according to the embodiment may also determine the creditworthiness of the first company based on the information content data, such as news data. The information content data can possibly be, similarly to the search data, used as the index value for measuring the degree of attention of general users. Consequently, with this configuration, the determination device 100 can also determine the creditworthiness of the first company from various points of view.

Furthermore, the acquiring unit 131 acquires information content data that is positive for the second company or the information content data that is negative for the second company. The determination unit 133 determines the creditworthiness of the first company based on the information content data positive for the second company or the information content data negative for the second company.

In this way, the determination device 100 according to the embodiment can determine the creditworthiness by taking into account the content of the article. Consequently, the determination device 100 can improve the accuracy of the determination process of the creditworthiness.

Furthermore, the acquiring unit 131 acquires, as the evaluation information, the information related to the advertisement placed by the second company. The determination unit 133 determines the creditworthiness of the first company based on the information related to the advertisement placed by the second company.

In this way, the determination device 100 according to the embodiment may also determine the creditworthiness of the first company. The advertisement is an investment to inform the general public of company's business and it is assumed that companies that spend the cost of advertisements are the companies that correspondingly have the credibility by the same amount. Furthermore, it is also possible to determine that the first company that conducts business with such a second company is highly likely to be a company with the credibility. In this way, the determination device 100 can determine the creditworthiness of the first company from various points of view.

Furthermore, the acquiring unit 131 acquires, as the evaluation information, the information related to search advertising placed by the second company. The determination unit 133 determines the creditworthiness of the first company based on the advertisement fee or the advertisement ranking related to the search advertising placed by the second company.

In this way, the determination device 100 according to the embodiment may also determine the creditworthiness of the first company by paying attention to the cost related to the search advertising. Because search advertising bids for a search keyword, search advertising is actively used by the companies that appeal their business in association with some keywords. Furthermore, it can be said that the companies that spend the cost of such advertisements are the companies that correspondingly have the credibility by the same amount. Furthermore, it is also possible to determine that the first company that conducts business with such a second company is highly likely to be a company with the credibility. In this way, the determination device 100 can determine the creditworthiness of the first company from various points of view.

Furthermore, the acquiring unit 131 acquires, as the evaluation information, a predetermined evaluation value at the time of evaluation of the second company performed by an external institution evaluates. The determination unit 133 determines the creditworthiness of the first company based on the predetermined evaluation value at the time of evaluation performed by the external institution.

In this way, the determination device 100 according to the embodiment may also determine the creditworthiness of the first company by using the evaluation value of the external institution. Namely, the determination device 100 can improve the credibility of the obtained creditworthiness by performing the determination process using the credible data, such as data of the external institution, known to the general public.

Furthermore, the acquiring unit 131 acquires the evaluation information related to the first company. The determination unit 133 determines the creditworthiness of the first company based on the evaluation information related to the first company in addition to the evaluation information on the second company.

In this way, the determination device 100 according to the embodiment may also perform the determination process by using not only the information on the second company having a business relationship with the first company but also the information on the first company itself. Consequently, because the determination device 100 can perform determination from a larger number of pieces of information, it is possible to improve the accuracy of the process.

Furthermore, the acquiring unit 131 acquires the information on the deposit/withdrawal transaction between the second company specified by the specifying unit 132 and the first company. The determination unit 133 determines the creditworthiness of the first company based on the information related to the deposit/withdrawal transaction between the first company and the second company and the evaluation information related to the second company.

In this way, the determination device 100 according to the embodiment may also determine the creditworthiness of the first company by taking into account the information (a deposit/withdrawal relationship) on the deposit/withdrawal transaction in addition to the evaluation information related to the specified second company. Consequently, because the determination device 100 can perform determination from a larger number of pieces of information, it is possible to improve the accuracy of the process.

Furthermore, the determination unit 133 determines the creditworthiness of the first company by using, as the information related to the deposit/withdrawal transaction, at least one of the transaction amount between the first company and the second company, the number of transactions, the transaction frequency, the transition of transaction amount, the transition of the number of transactions, and the transition of the transaction frequency.

In this way, the determination device 100 according to the embodiment may also use, for the determination process, various kinds of information as the information on the deposit/withdrawal transaction. Consequently, the determination device 100 can determine the creditworthiness of the first company from various points of view.

Furthermore, the determination device 100 according to the embodiment further includes the creating unit 134 that creates, based on the information related to the deposit/withdrawal transaction between the first company and the second company and based on the creditworthiness of the first company determined by the determination unit 133, the graph W10 indicating the relationship between the first company and the second company and the providing unit 135 that provides the graph W10 created by the creating unit 134.

In this way, the determination device 100 according to the embodiment may also create the graph W10 in which the information related to the first company can be visually provided. Consequently, because the determination device 100 can allow the first company that is trustworthy as a borrower to be visually recognized, it is possible to improve the usability on the financial institution side that uses the data provided by the determination device 100.

Furthermore, the creating unit 134 creates the graph W10 in which the relationship is more visually emphasized as a transaction amount between companies is greater in the information related to the deposit/withdrawal transaction.

In this way, the determination device 100 according to the embodiment may also create the graph W10 in which the visibility is changed in accordance with the actual transaction state. Consequently, the determination device 100 can provide the information further superior in visibility.

Furthermore, the creating unit 134 creates the graph W10 in which the relationship is more visually emphasized as the transition of the transaction amount in the companies in a predetermined time period is greater in the information related to the deposit/withdrawal transaction.

In this way, the determination device 100 according to the embodiment may also create the graph W10 in which the visibility is changed in accordance with the actual transaction state. Namely, the determination device 100 can create the graph W10 in which it is possible to judge the first company that is expected to grow or the first company that expands its business at a glance, which makes it possible to provide the information further superior in visibility.

Furthermore, the creating unit 134 creates the graph W10 in which the relationship is more visually emphasized as the period of the business relationship between the companies is longer in the information related to the deposit/withdrawal transaction.

In this way, the determination device 100 according to the embodiment may also create the graph W10 in which the visibility is changed in accordance with the actual transaction state. Namely, the determination device 100 can create the graph W10 in which it is possible to judge the companies having a close trust relationship at a glance, which makes it possible to provide, to the financial institution, information used to make a decision, such as information indicating what kind of the first company is decided to be a borrower, represented in a simply way.

Furthermore, the determination device 100 according to the embodiment further includes the receiving unit 136 that receives a predetermined request with respect to the graph W10. When a request for selection of the predetermined first company is received by the receiving unit 136, the creating unit 134 newly creates the graph W10 in which the relationship between the predetermined first company and the second company is indicated by using the predetermined first company as the reference point. The providing unit 135 provides the graph W10 newly created by the creating unit 134 to the sending source that sent the predetermined request.

In this way, the determination device 100 according to the embodiment may also provide the graph W10 in which the information to be displayed is changed in accordance with a desired from the financial institution side. Consequently, the determination device 100 can improve the usability of the financial institution side that uses the provided graph W10.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

Furthermore, the determination device 100 described above may also be implemented by a plurality of server computers. In addition, the structure may be changed flexibly depending on functions. The functions may be implemented by calling an external platform or the like by an application programming interface (API) or network computing.

Furthermore, “a unit (section, module, unit)” recited in the claims may be read as “means”, “circuits”, or the like. For example, the acquiring unit may be read as an acquiring means or an acquiring circuit.

According to an aspect of an embodiment, an advantage is provided in that it is possible to appropriately extract a company that becomes a borrower.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A determination device comprising:
an acquiring unit that acquires account information that is information related to a transaction of an account opened by a first company and evaluation information that is information related to evaluations of companies;
a specifying unit that specifies, based on the account information acquired by the acquiring unit, a second company that has a deposit/withdrawal transaction with the first company; and
a determination unit that determines, based on the evaluation information related to the second company specified by the specifying unit and based on the information related to the deposit/withdrawal transaction between the first company and the second company, creditworthiness of the first company.

2. The determination device according to claim 1, wherein
the acquiring unit acquires, as the evaluation information, stock price information related to the second company, and
the determination unit determines, based on the stock price information related to the second company, the creditworthiness of the first company.

3. The determination device according to claim 1, wherein
the acquiring unit acquires, as the evaluation information, exchange information in an economic bloc to which the second company belongs, and
the determination unit determines, based on a relationship between an industry to which the second company belongs and exchange, the creditworthiness of the first company.

4. The determination device according to claim 1, wherein
the acquiring unit acquires, as the evaluation information, search data related to the second company, and
the determination unit determines, based on the search data related to the second company, the creditworthiness of the first company.

5. The determination device according to claim 1, wherein
the acquiring unit, as the evaluation information, information content data related to the second company, and
the determination unit determines, based on the information content data related to the second company, the creditworthiness of the first company.

6. The determination device according to claim 5, wherein
the acquiring unit acquires the information content data positive for the second company or the information content data negative for the second company, and
the determination unit determines, based on the information content data positive for the second company or the information content data negative for the second company, the creditworthiness of the first company.

7. The determination device according to claim 1, wherein
the acquiring unit acquires, as the evaluation information, information related to an advertisement placed by the second company, and
the determination unit determines, based on the information related to the advertisement placed by the second company, the creditworthiness of the first company.

8. The determination device according to claim 7, wherein
the acquiring unit acquires, as the evaluation information, information related to search advertising placed by the second company, and
the determination unit determines, based on an advertisement fee or an advertisement ranking related to the search advertising placed by the second company, the creditworthiness of the first company.

9. The determination device according to claim 1, wherein
the acquiring unit acquires, as the evaluation information, a predetermined evaluation value at the time of evaluation of the second company performed by an external institution evaluates, and
the determination unit determines, based on the predetermined evaluation value at the time of evaluation performed by the external institution, the creditworthiness of the first company.

10. The determination device according to claim 1, wherein
the acquiring unit acquires the evaluation information related to the first company, and
the determination unit determines, based on, in addition to the evaluation information related to the second company, the evaluation information related to the first company, the creditworthiness of the first company.

11. The determination device according to claim 1, wherein
the determination unit determines the creditworthiness of the first company based on, as the information related to the deposit/withdrawal transaction, at least one of a transaction amount between the first company and the second company, the number of transactions, a transaction frequency, the transition of the transaction amount, the transition of the number of transactions, and transition of the transaction frequency.

12. The determination device according to claim 1, further comprising:
a creating unit that creates, based on the information related to the deposit/withdrawal transaction between the first company and the second company and based on the creditworthiness of the first company determined by the determination unit, a graph indicating a relationship between the first company and the second company; and
a providing unit that provides the graph created by the creating unit.

13. The determination device according to claim 12, wherein
the creating unit creates the graph in which the relationship is visually emphasized as the transaction amount between companies is greater in the information related to the deposit/withdrawal transaction.

14. The determination device according to claim 12, wherein
the creating unit creates the graph in which the relationship is visually emphasized as the transition of the transaction amount between the companies in a predetermined time period is greater in the information related to the deposit/withdrawal transaction.

15. The determination device according to claim 12, wherein
the creating unit creates the graph in which the relationship is visually emphasized as the period of a business relationship between the companies is longer in the information related to the deposit/withdrawal transaction.

16. The determination device according to claim 12, further comprising:
a receiving unit that receives a predetermined request with respect to the graph, wherein
when a request for selection of a predetermined first company is received by the receiving unit, the creating unit newly creates a graph indicating a relationship between the predetermined first company and the second company by using the predetermined first company as a reference point, and
the providing unit provides the graph newly created by the creating unit to a sending source that has sent the predetermined request.

17. A determination method performed by a computer comprising:
acquiring account information that is information related to a transaction of an account opened by a first company and evaluation information that is information related to evaluations of companies;
specifying, based on the account information acquired at the acquiring, a second company that has a deposit/withdrawal transaction with the first company; and
determining, based on the evaluation information related to the second company specified at the specifying and based on the information related to the deposit/withdrawal transaction between the first company and the second company, creditworthiness of the first company.

18. A non-transitory computer-readable storage medium having stored therein a determination program that causes a computer to execute a process comprising:
acquiring account information that is information related to a transaction of an account opened by a first company and evaluation information that is information related to evaluations of companies;
specifying, based on the account information acquired at the acquiring, a second company that has a deposit/withdrawal transaction with the first company; and
determining, based on the evaluation information related to the second company specified at the specifying and based on the information related to the deposit/withdrawal transaction between the first company and the second company, creditworthiness of the first company.
